(19) United States
(12) Patent Application Publication
(10) Pub. No.: US 2016/0047675 A1
(43) Pub. Date: Feb. 18, 2016

(54) Inertial Measurement and Navigation System And Method Having Low Drift MEMS Gyroscopes And Accelerometers Operable In GPS Denied Environments

(71) Applicant: Tanenhaus & Associates, Inc., Annapolis, MD (US)

(72) Inventors: Martin E. Tanenhaus, Annapolis, MD (US); Dean Carhoun, Lecanto, FL (US)

(21) Appl. No.: 13/886,735

(22) Filed: May 3, 2013

Related U.S. Application Data
(63) Continuation-in-part of application No. 13/562,970, filed on Jul. 31, 2012, now abandoned.
Application No. 13/562,970 is a continuation of application No. 12/431,132, filed on Apr. 28, 2009, now Pat. No. 8,239,162.
Application No. 12/431,132 is a continuation of application No. 11/279,608, filed on Apr. 13, 2006, now Pat. No. 7,526,402.
(60) Provisional application No. 60/672,724, filed on Apr. 19, 2005.

(51) Int. Cl. G01C 25/00; G01C 21/16

(52) U.S. Cl. CPC G01C 25/005; G01C 21/16

(57) ABSTRACT

An inertial measurement unit includes physically distinct sectors positioned in groups of orthogonally oriented angle rate sensors on a different sector of a base having orthogonally oriented accelerometers positioned thereon. A processor receiving signals from the sensors and accelerometers calculates a change in attitude, position, angular rate, velocity, acceleration of the unit over a plurality of finite time increments, or a combination thereof. The gyros and accelerometers have low-drift measurement accuracy for operation in a GPS-denied environment by preselecting pairs of gyros for physical assignment to achieve low-drift accuracy, determining weights for the gyros to be combined in tiered pairs, preselecting the accelerometers for physical assignment in low-drift pairs, determining weights for accelerometer optimal low-drift pair combining in tiers, or a combination thereof.

### CROSS-REFERENCE TO RELATED APPLICATIONS

This application is a continuation-in-part application of patent application Ser. No. 13/562,970 for Miniaturized Inertial Measurement Unit and Associated Methods, filed Jul. 31, 2012 which itself is a continuation of patent application Ser. No. 12/431,132, for Miniaturized Inertial Measurement Unit and Associated Methods, filed Apr. 28, 2009 and issuing as U.S. Pat. No. 8,239,162 which itself is a continuation-in-part of patent application Ser. No. 11/279,608, filed Apr. 13, 2006, issuing as U.S. Pat. No. 7,526,402 which itself claims priority to Provisional Application Ser. No. 60/672,724, filed on Apr. 19, 2005, entitled Shock-Hardened Integrated 3D MEMS Gyro/Accelerometer and DSP Inertial Measurement Unit, the disclosures of which are herein incorporated by reference in their entirety and all commonly owned.

### FIELD OF INVENTION

The present invention generally relates to inertial measurement and navigation devices, and in particular to embedded signal processing.

### BACKGROUND

An inertial measurement unit (IMU) is a closed system that is used to detect changes in angular rate and velocity. As a closed system it is used to detect attitude and motion changes, and can be employed to determine the motion of a carrier, such as aircraft, and geo-location measurements on sensor equipment, wearable computing, e.g., as in movement detection measurements of soldiers operating on the ground, and camera stabilization platforms. A conventional IMU detects acceleration and rate of change in attitude (i.e., roll, pitch, and yaw rates) and measures these parameters over time to find the total change from the initial position. A conventional IMU is not an inertial navigation system, since it does not know its own location, but an extended IMU can provide additional data such as velocity, position, heading attitude, pitch, roll, angular rates, and acceleration with inherent error correction, with accuracies many orders of magnitude greater than that of an inertial navigation unit. By way of example, an extended IMU contains partial navigation solutions embedded into an algorithm suite.

An IMU does not detect linear velocity and position directly, which are computed parameters, by integration and double integration, based on measured accelerations, angular rates, and initial conditions. Small errors in acceleration can cause large errors in velocity and position.

Conventional IMUs are generally associated with high cost, large bulk, high power consumption, limited lifetime, and long turn-on time. The high cost and large size in particular have generally precluded application of IMUs to technologies such as geolocation measurements on sensor equipment; wearable computing (e.g., in movement detection measurements of soldiers operating on the ground), and camera stabilization platforms.

Other difficulties with conventional IMUs include accumulated error, since the IMU is continually adding detected changes to the current position, and any error in the measurement is cumulative, leading to “drift.” Such drift can comprise errors in a range of 100-200 deg/h.

Navigation systems can also employ global positioning satellite (GPS) system to correct for long-term drift in position determination by the IMU.

Micro Electro-Mechanical System (MEMS) technology has resulted in the development of a micro, low-cost IMU that comprises MEMS angular rate and acceleration sensors on silicon chips. However, despite their enormous cost, size, weight, thermal stability, and wide dynamic range advantages over conventional inertial sensors, the MEMS IMUs generally yield less precise and accurate measurements relative to their conventional IMU counterparts.

It is also known to use a high-precision positioning and data integrated system comprising a MEMS IMU, two GPS systems providing raw data, and a centralized processing module that comprises Kalman filter integration to correct various measurement errors such as tilt angle shifts, velocity error, and accelerometer errors received by the device's navigation module. However, GPS systems may be blocked by obstructions, thereby reducing the effectiveness of the system.

The concept of a “virtual gyro” has also been explored, wherein gyroscopes are replaced with an array of relatively inexpensive accelerometers. The system comprises distributed accelerometers combined with a multiple-antenna, GPS-based, attitude-determination system. In this system, however, accelerometer noise is known to be a major source of error in both angular and linear parameters. However, it would appear that the resulting GPS attitude measurement is potentially inaccurate, vulnerable to loss of multiple GPS signals, and relatively slow in updates relative to an inertial system that uses gyros. It is also cumbersome, requiring an antenna array.

One critical cause of error in position measurement (double integrated accelerometer value) is error in the orientation determined by the gyros. This is so because the maturity of the device above the noise floor or MEMS accelerometers, now in the 100-mg class, has put extreme pressure on the pitch and roll accuracy to reach the same level of performance, which is far more difficult for the gyros than for the accelerometers.

While embodiments of the invention disclosed in the related U.S. Pat. No. 7,526,402 advanced the field of IMUs significantly, further development and testing determined that additional algorithm and packaging improvements are desirable for meeting predetermined criteria for accuracy and robustness when used under more demanding stand-alone conditions. Therefore, it would be advantageous to provide an improved algorithm suite and improved packaging for an IMU for use, for example, in such GPS denied unassisted demanding conditions.

### SUMMARY

The teachings of the present invention provide embodiments that may including a self-contained, integrated micro-cube-sized IMU in which component sensors can provide not only changes in angular rate and velocity, but also attitude, azimuth, position, and velocity data to high accuracy. The accuracy is achieved through the use of specifically oriented sensors, the orientation serving to substantially cancel noise and other first-order effects, and the use of denoising algorithms to reduce the noise of MEMS gyro and accelerometer devices, and an error-correcting algorithm such as a Kalman filter embedded in a digital signal processor (DSP) device. In an additional DSP, a navigation-grade Kalman filter algorithm couples to the IMU to provide navigation-grade performance results. The IMU Kalman filter and the navigation-grade KF algorithm exhibit a synergistic effect whereby more accurate results are obtained through a reduction in sensor bias than if the IMU filter or algorithm is used alone. Since the navigation KF algorithm normally requires floating-point computations, a separate computational engine is dedicated to its operation.

The multi-sensor fusion technology according to the teachings of the present invention is accelerating development of accurate MEMS sensor-based inertial navigation in situations where GPS does not operate reliably (herein referred to as GPS-denied environments). Embodiments of the invention have demonstrated that one inertial device per axis is not sufficient to produce low drift errors for long term accuracy needed for GPS-denied applications, thus desirable embodiments use arrays of off-the-shelf MEMS inertial sensors to create an inertial measurement unit (IMU) suitable for inertial navigation systems (INS) that require only occasional GPS updates. Compared to fiber optics gyros, properly combined MEMS gyro arrays are of desirably lower cost, desirably fit into a smaller space, use less power and have equal or better performance. Inertial measurement units based on the teachings of the present invention have demonstrated approximately 100 times lower sensor drift error to support very accurate angular rates, very accurate position measurements, and very low angle error for long durations.

By way of example, embodiments as herein described may occupy small volume, have low weight, and consume relatively little power. A complete assembly can be potted in a protective sheath to form a rugged standalone product. An external exoskeleton case may be provided to protect electronic assembly for munitions and UAV applications, by way of example. A user is provided with accurate real-time navigational information in difficult situations where GPS is not reliable. One desirable feature to such accurate performance for GPS denied situations is a low sensor drift error. The IMU/INS responds to quick movements without introducing delays while sharply reducing sensor drift errors that result in significant navigation errors over long durations.

Other features for use as an IMU/INS device may include 1) user friendly settings making it simple to operate; 2) when operating on battery power, embedded power management provides long duration field operation; 3) initial bearing accuracy consistent with tactical requirements; 4) unaffected by varying magnetic dip angles and other magnetic field disturbances since it does not use a magnetic compass for bearing estimation; 5) Integrated Advanced Heading Reference System (AHRS) with a nonlinear accurate azimuth bearing, as will be further addressed below; 6) dual non-interfering conversion channels for parallel processing of each MEMS subarray to facilitate accurate north-finding and gyrocompass tracking if required; 7) IMU performance improvement due to array performance multiplier effect as individual MEMS inertial sensors characteristics improve; 8) an asynchronous serial connection to enable GPS-aided operation if desired; and 9) a simple fabrication process for large-quantity production to lower unit cost significantly.

In a particular embodiment, an inertial measurement unit of the present invention may comprise a base comprising a plurality of physically distinct sectors. Three sets of angle rate sensors are orientable triaxially in a first direction, each set mounted on a different sector of the base orientable normal to the other two and comprising N gyroscopes oriented at 360/N-degree increments, where N≧2. Three further sets of angle rate sensors are orientable triaxially in a second direction opposite the first direction, each set mounted on a different sector of the base orientable normal to the other two and comprising N gyroscopes oriented at 360/N-degree increments, where N≧2.

At least one accelerometer is positioned on the base adapted to provide three signals containing triaxial accelerometer data as well as, with heavy filtering on these outputs, three additional signals that contain inclination pitch, roll, and yaw data. Note that arrays of accelerometer devices may be arranged exactly the same way as the gyro devices to eliminate or greatly reduce dc errors, although this is not intended as a limitation. Means are provided for outputting signals from the six sets of angle rate sensors, the three accelerometer signals, and three inclination signals to a processor for calculating at least one of a change in attitude, position, angular rate, acceleration, and velocity of the unit.

Embodiments of the invention can sustain G forces that could affect the integrity of the IMU's components and hence the accuracy of the angular rate, acceleration, and location measurements through the use of a semi-rigid flex board containing the sensors and the DSP. The semi-rigid flex board can be housed in a protective structure that permits the sensors and DSP IMU to survive high G environments with little or no potting and remain precisely aligned in all three dimensions to measure range, pitch, and yaw of, for example, guided munitions during flight.

Embodiments of the invention can provide a means of measuring angular rates and acceleration when GPS data are not present for long periods of dead time. An on-board GPS can be integrated with the IMU to initiate accurate solutions when GPS data are available.

Embodiments of the invention also may provide a fully integrated IMU containing a magnetometer for determining the down position of the navigational carrier to avoid orientation problems and to report true North.

One fully integrated IMU according to the teachings of the present invention may be lightweight and compact in size for mounting on individuals, such as soldiers, to detect movement, as well as to determine instantaneous motion change and new position on low-cost stabilization platforms. By way of example, one desirable embodiments of the invention may have a volume less than 1.9 in.³ and a weight of less than 0.05 pound.

An additional feature of embodiments of the present invention is directed to an integrated IMU that can be assembled in a plane on a base having a plurality of sectors that are foldable relative to each other to create a three-dimensional device wherein the sectors have a predetermined and desired orientation relative to each other.

The gun-rugged sensor array data fusion approach according to the teachings of the present invention significantly improves the performance over a single gyro per axis by combining multiple devices in an optimum way using both hardware alignment techniques and algorithms processed in its embedded DSP. As more performance is required, the virtual design can be exploited to achieve improved performance. One important feature implemented is the use of a combination of algorithms to gain improved performance and the alignment of hardware devices to reduce dc errors. A set of gyro devices for each axis is oriented into an array of devices that reduces the dc errors common to all MEMS gyros. Although a set of gyros made up of two subarrays must use exactly the same count, in a particular embodiment each axis comprises an array of two subarrays equal to eight gyro devices.

Although MEMS gyros and accelerometers typically provide imprecise data due to bias drift and turn-on instability, the sensor fusion IMU specifically attempts to cancel both gyro and accelerometer bias and bias drift terms and misalignment errors, acceleration errors (G-sensitive), nonlinear (square term), and scale factor errors. A gyro array layout to cancel most dc errors and a pre-filter designed to denoise the resulting signal eliminates errors typically associated with the bias terms.

The combined array gyro signals are processed separately and can be selected as a single channel, the running average of 8 channels, or a twin matrix of opposing 4×4 signals. The devices in each matrix are summed and then either denoising filters are applied to each data stream before subtraction or the two streams are subtracted one from the other and the denoising filters applied to the difference. The wavelet denoising algorithm improves the performance of a selected set of gyros in each axis. The wavelet denoising algorithm can be applied to a single gyro channel per axis, or to multiple gyros processed as the sum of the top set of devices in the array. The denoising algorithm can be applied to a single accelerometer channel per axis or multiple accelerometers can be combined and processed to reduce the drift and dc errors.

Based on physical placement of a plurality of sensors, including both gyros and accelerometers, an improved process for combining sensors has been implemented and tested to minimize noise and long-duration drift on each axis of each type of sensor. This is implemented systematically in stages, each stage contributing reduced drift in the combined sensor outputs. This process proceeds from selection of low-drift paired sensors prior to their assignment to physical positions in the IMU hardware.

With such improved aspects, and an addition of a suitable digital signal processor (DSP), embodiments of the invention go beyond an inertial measurement unit (IMU) providing inertial sensor outputs to an Integrated Navigation System (INS), but may be employed as an integral unit for practical deduced reckoning (dead-reckoning) without requiring an excessive rate of accuracy updating from external references such as a GPS.

One embodiment is directed to an IMU that may comprise precision inertial measurement technology and an embedded advanced heading algorithm suite. The device comprises a base having a plurality of physically distinct sectors. Three groups of orthogonally oriented angle rate sensors are provided, each group positioned on a different sector of the base, for providing data for each of the x,y,z axes. Three high-G orthogonally oriented accelerometers are also positioned on the base, as well as three low-G orthogonally oriented accelerometers. The unit occupies a volume of less than 2.2 in.³, weighs less than 70 g, and consumes less than 2 W of power.

A processor is positioned on the base having means resident thereon for receiving signals from the three groups of angle rate sensors/gyros and the three high-G and three low-G accelerometers. By “high-G” is meant here ±35 G or higher; “low-G” is intended to mean <4 G. Means are also resident on the processor for calculating one or more of the following: a change in attitude, a change in position, a change in angular rate, a change in velocity, and a change in acceleration of the unit over a plurality of finite time increments.

The calculating means may comprise a near-real-time embedded algorithm suite that has been found to significantly enhance the accuracy of the device over those known in the art. Each gyro is made into a precision instrument for stabilizing gyro drift by leveraging factory measurement data provided with each commercial-off-the-shelf (COTS) gyro. These data are used to perform temperature drift and null sensitivity compensation with a fixed-point algorithm operating in the background, which was found to increase sensitivity, lower drift significantly, and stabilize performance. After this compensation, dc offset removal was performed for each gyro to achieve upgraded precision performance including drift stabilization. Individual gyro oversampling was performed. This feature reduces noise and resamples for the follow-on embedded algorithm. In a particular embodiment, the gyros are then combined into orthogonal arrays with the outputs averaged and wavelet-filtered to reduce noise.

The accelerometers are used to measure both high- and low-G acceleration in three dimensions and establish proper alignment of the module sensor suite. Data from these accelerometers are processed by the wavelet denoising algorithm.

A Kalman-filtered bias compensation algorithm is then applied to achieve better than 0.24 deg/h in-run gyro bias stability in all three axes that are implemented with embedded fixed-point computations. The reported results were measured from Allan variance computations of the near-real-time data from several different IMU hardware units and are expected to improve with further development.

Matlab may be used to post-process IMU wavelet-denoised data records in double-precision floating point format. Each of the three orthogonally positioned precision gyro arrays, and their associated processing, achieves less than 0.1 deg/h gyro bias drift, and less than 2 mil angle drift over 5 h duration for the static case based on laboratory testing. The prototype IMU occupies less than 2.2 cubic inches, weighs less than 70 g, and consumes less than 2 W of power. An angle random walk (ARW) of less than 0.4 deg/h^{1/2} on each axis was measured.

Present laboratory measurements for the present IMU's include, but are not intended to be limited to: factory-settable angular range: Model C: ±250 deg/s; Model D: ±1125 deg/s; Allan deviation based in run gyro stability of 0.05 to 0.3 deg/h per gyro channel; rate-integrated angle error measurements of 1.0-2.0 mil over 5 h duration; accelerometer bias stability of 0.07-0.1 mg; 2.2 cu in., 70 g, <2.2 W power from 7-24 V input; optional protected enclosed package design; and near-real-time operation.

The excellent results measured for some gyro channels indicate that further work will produce IMU/INS modules with even better performance. Several new features now form part of the software package. When surface micro-machined sensors are treated not as individual instruments but as arrays of precise instruments, the positioning of the devices in the module, as well as the fusion and filtering mathematics, reduce the inherent silicon noise sources and maximize the individual device performance.

Although the chips from Analog Devices, Inc. (ADI) were selected for this preproduction batch of IMUs, this technique can be applied to any single- or multiple-axis devices. In the pre-production unit fabrication process, no care was taken to pre-select gyro devices to be placed on a specific semi-rigid flex board assembly, or specifically identified to be placed in the positions on the board representative of a specific virtual gyro axis. It is believed that with these selection criteria, the performance of each virtual gyro axis will be optimized to another level of performance. In keeping with above described structural embodiments of the invention, one aspect of the invention comprises methods for evaluating and selecting gyros and accelerometers. One method may comprise a method for selecting gyros and accelerometers operable in an inertial measurement unit and navigation system to achieve low-drift measurement accuracy for operation in a GPS-denied environment, wherein the method may comprise preselecting pairs of gyros for IMU physical assignment to achieve low-drift measurement accuracy; determining optimal eights for gyros to be combined in tiered pairs exhibiting low drift; combining assigned gyro pairs based on quadratic optimization to achieve low-drift; determining weights for accelerometer optimal low-drift pair combining in tiers; combining assigned accelerometer pairs in aggregate for low drift using pair weight selection by minimization of a quadratic form; or a combination thereof.

By way of further example, a method may include preselecting gyros for an IMU assignment in pairs; combining gyros based on pairs for low-drift; determining weight for gyros to be combined in tiered pairs; process for combining gyros based on constrained optimization for gyro low-drift; process for preselecting individual accelerometers for IMU assignment in pairs, wherein the sensors are not physically constrained; process for preselecting individual accelerometers for IMU assignment in pairs, wherein the sensors are tri-axially constrained; determining weight for accelerometer low-drift pair combining, wherein the sensors are not physically constrained; determining weight for accelerometer low-drift pair combining, wherein the sensors are tri-axially constrained; using constrained optimization of an accelerometer low-drift combining process, wherein the sensors are either not physically constrained or tri-axially constrained; and a combination thereof.

### BRIEF DESCRIPTION OF THE DRAWINGS

Features that characterize embodiments of the invention, both as to organization and method of operation, will be better understood from the following description used in conjunction with the accompanying drawings. It is to be expressly understood that the disclosure and drawings are herein presented for the purpose of illustration and description and are not intended to be limiting. Advantages offered by embodiments of the present invention will become more fully apparent with reference to the accompanying drawings, in which:

FIG. 1 is a top plan view of a first embodiment of an inertial measurement unit of the present invention illustrating a four-panel semi-rigid flex board member;

FIG. 2 is a bottom plan view of the embodiment of FIG. 1;

FIG. 3 is a block diagram illustrating components of the embodiment of FIG. 1;

FIG. 4 is an exemplary connector and voltage regulator circuit for the embodiment of FIGS. 2 and 3;

FIG. 5 is an electronics block diagram of one embodiment of the inertial measurement unit illustrated by way of example in FIG. 1;

FIG. 6 is a top plan view of a second embodiment of the invention illustrated by way of example, wherein sensor module comprise three eight-member arrays of MEMS gyros;

FIG. 7 is a perspective view of a support member for the embodiment of FIG. 1, illustrated herein by way of example;

FIG. 8 is a functional flow block diagram illustrating exemplary computations that make up a Kalman filter solution through inclusion of a virtual gyro computation;

FIG. 9 is a diagrammatical illustration of folded modules that may be employed for an embodiment as illustrated by way of example in FIG. 10;

FIG. 10 is a top plan view of a fourth embodiment of the invention illustrating one flex circuit for a 3D virtual gyro/accelerometer system by way of further example;

FIG. 11 is a top plan view of a fifth embodiment of an inertial measurement unit according to the teachings of the present invention;

FIG. 12 diagrammatically illustrates one gyro layout by way of example for achieving error cancellation;

FIG. 13 is a top-side perspective view of the embodiment of FIG. 11 illustrated in a folded device configuration;

FIG. 14 is an exemplary block diagram of one electronics layout for the embodiment of FIG. 11;

FIG. 15 is a functional flow block diagram illustrating functionality performed in a digital signal processor (DSP) according to the teachings of the present invention;

FIG. 16 is a functional flow block diagram illustrating functionality of one inertial measurement unit according to the teachings of the present invention;

FIGS. 17 and 18 are flowcharts for two alternative methods for correcting bias errors, herein presented by way of example;

FIG. 19 illustrates data flow from sensors through a Kalman filter to an IMU output;

FIGS. 20-25 diagrammatically illustrate an assembly of an embodiment including flex board to a final assembly, by way of example;

FIG. 26 is a block diagram illustrating one process for converting gyros to precision instruments;

FIG. 27 is an Allen distribution curve for x, y, and z-axis gyros for an embodiment of an IMU device;

FIG. 28 is a block diagram of one functional flow for IMU calculations;

FIG. 29 is an Allen distribution curve for x-, y-, and z-axis gyros for another embodiment of an IMU device;

FIG. 30 is an exploded diagrammatical illustration of components of an exemplary embodiment of an IMU illustrating an orientation thereof, by way of example;

FIG. 31 is a flowchart of details of an exemplary gyro drift compensation architecture;

FIG. 32 is a flowchart of details of an exemplary residual gyro-bias compensation applied to a quaternion angle representation;

FIG. 33 is an exploded view of an exemplary exoskeleton housing for one IMU according to the teachings of the present invention;

FIG. 34A illustrates one embodiment of the invention illustrated in an un-potted gyro cubes, each orthogonally positioned before attachment to a main board;

FIG. 34B illustrates a main processor board wrapped around the gyro cubes of FIG. 34A;

FIGS. 35A, 35B and 35C illustrate an exoskeletal shock protected enclosed case, a bottom case portion, and a cover, respectively;

FIG. 36 is a functional block diagram illustrating one process according to the teachings of the present invention for combining low-drift gyro pairs in successive tiers;

FIG. 37 is a functional block diagram illustrating a process according to the teachings of the present invention for combining low-drift gyro pairs in aggregate;

FIG. 38 is a functional block diagram illustrating one process according to the teachings of the present invention for combining low-drift accelerometer pairs in successive tiers;

FIG. 39 is a functional block diagram illustrating one process according to the teachings of the present invention for combining low-drift accelerometer pairs in aggregate;

FIG. 40 is a graphic illustrating gyro angle versus cluster time of an Allan deviation for gyros with paired low-drift sensors indicating reduced-slope RRW curve;

FIG. 41 is a graphic illustrating acceleration versus cluster time of an Allan deviation for accelerometers with paired low-drift sensors indicating reduced-slope RRW curve;

FIG. 42 is a graphic illustrating acceleration versus cluster time of an Allan deviation for accelerometers with paired low-drift sensors indicating reduced-slope RRW curve;

FIG. 43 is a graphic illustrating integrated angle rate versus time showing reduction of gyro angle drift using direct measurement for sub-optimal pair-combining weights;

FIG. 44 is a graphic illustrating angle versus time showing reduction of gyro angle drift using statistical ensemble-average RMS estimate for sub-optimal combining;

FIG. 45 is a graphic illustrating velocity versus time showing reduction of accelerometer velocity drift using direct measurement for sub-optimal pair-combining; and

FIG. 46 is a graphic illustrating velocity versus cluster time showing reduction of accelerometer velocity drift using statistical ensemble-average RMS estimate for sub-optimal combining.

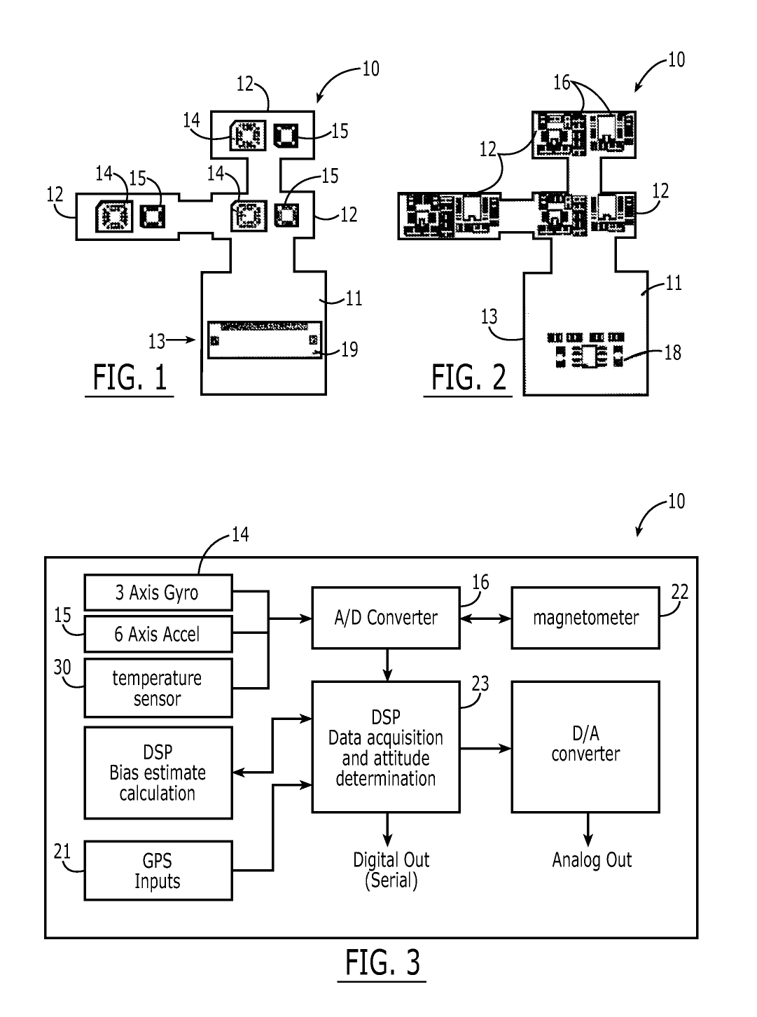

### DETAILED DESCRIPTION

Embodiments of the present invention will now be described by way of example, wherein one embodiment includes a self-contained, integrated micro-cube-sized IMU in which MEMS gyros and MEMS accelerators provide high-accuracy attitude, azimuth, relative position, and velocity. The semi-rigid flex circuit that forms the base in a particular embodiment can be housed in a protective structure that allows all components (electrical and mechanical) to survive high-G environments with little or no potting and remain precisely aligned in all three dimensions to measure range, pitch, and yaw during movement.

In a first embodiment of an inertial measurement unit 10 of the present invention, a semi-rigid flex board member 11 comprises three panels 12 representing each axis (x, y, and z) and a fourth panel 13. Each of the panels 12 comprises one MEMS gyro sensor element 14, two acceleration sensors 15, and two analog-to-digital converters (ADCs) 16 affixed to the respective panel.

As shown in FIG. 2, the process board member 17 comprises a power conditioning circuit 18 and a micro-connector 19, both of which are affixed to panel 13. The micro-connector 19 comprises both analog and digital data and input ports to initialize all the self-test inputs on all three MEMS gyro sensors 14 and all six MEMS accelerometers 15.

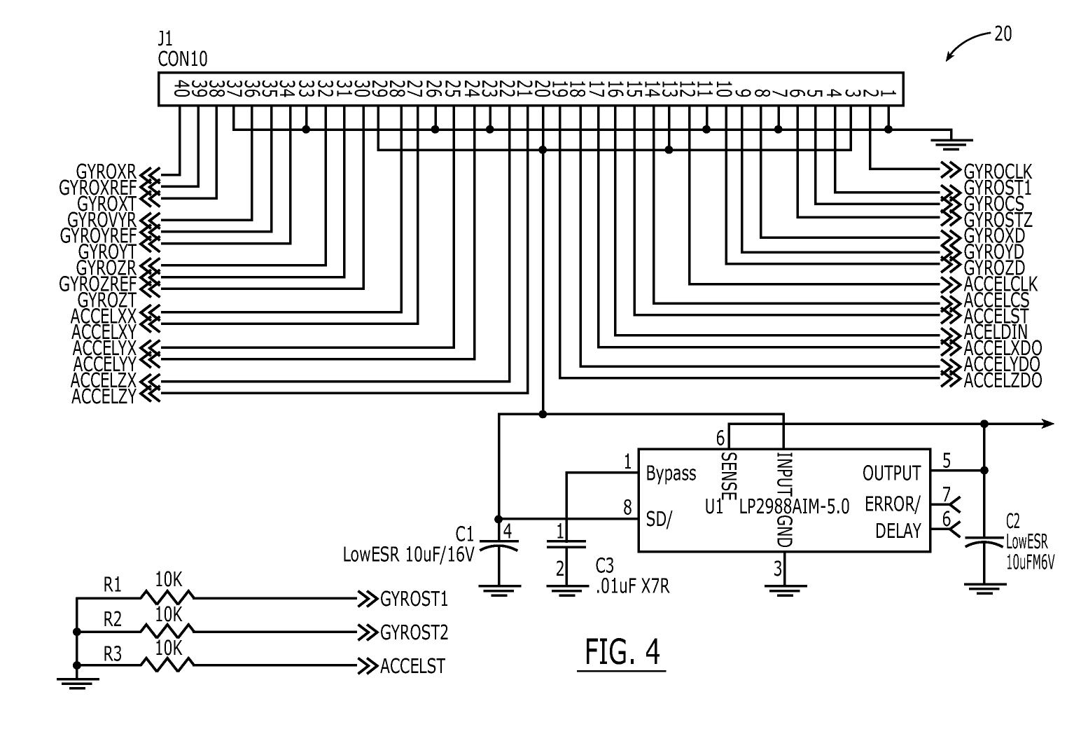

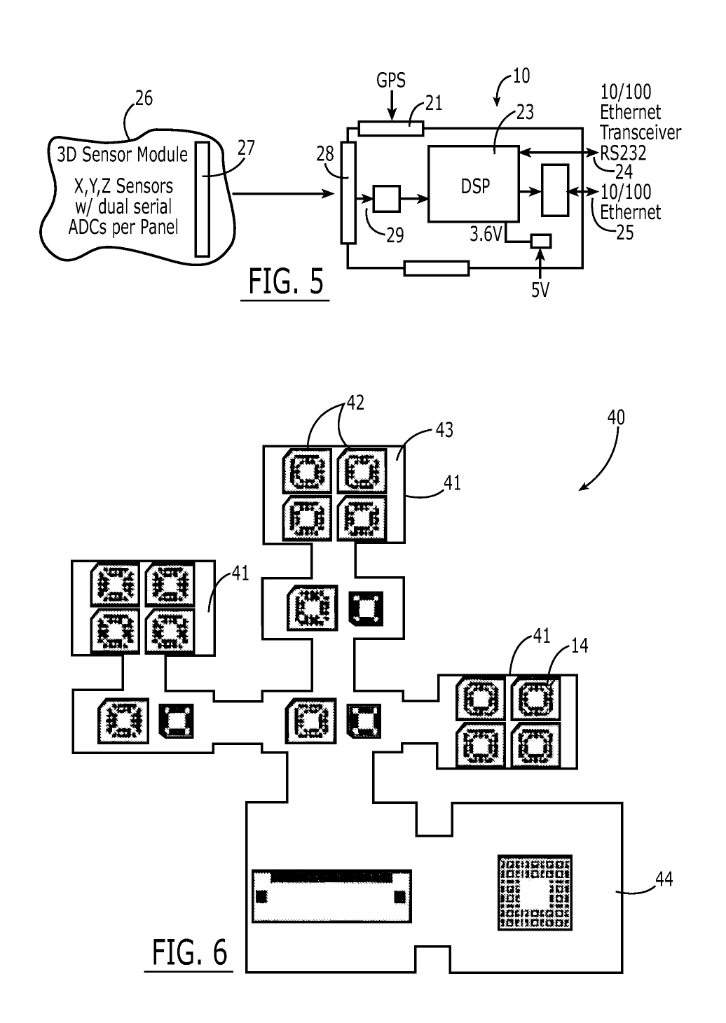

FIG. 3 is a block diagram of the integrated system for the above-described IMU's operating system. FIG. 4 is an exemplary connector and voltage regulator circuit 20 for the flex board member 11. The IMU device's operating system is capable of producing both a digital output and an analog output due to the inclusion of the ADCs 16. The ADCs 16 interface directly to a separate digital signal processor (DSP) board (see FIG. 5) to process the combination of the gyro 14, the accelerometers 15, GPS 21, and magnetometer 22 inputs to be processed as required for the stabilization platform application.

The DSP's 23 embedded software comprises resident sophisticated Kalman filters, GPS, and a navigation algorithm. An objective of using the Kalman filter is to reduce bias associated with both the MEMS gyro sensor 14 and the MEMS accelerator sensor 15. The software features both high-speed internal bus communication and external interface buses to other systems. Serial bus communications may include typical medium-speed RS232 24 as well as high-speed Ethernet links 25, as illustrated with reference to FIG. 5.

FIG. 5 is an electronics block diagram of the inertial measurement unit 10, illustrating the connection between the three-dimensional sensor module 26 and the flex board member 11 via, for example, 40-pin connectors 27,28. A complex programmable logic device (CPLD) 29 combines six serial digital buses into a format compatible with the DSP 23. In a particular embodiment, the device 10 features integrated magnetics, Internet readiness, a laptop GUI controller, and power management, all on a 1.2×1.2-in. board.

FIG. 6 shows another embodiment 40 of the invention wherein the 3D sensor module member 41 comprises an array 42 of eight MEMS gyros 14 on one of the axis panels 43 instead of the above embodiment of one MEMS gyro element 14 per axis. To further improve the device's performance, four MEMS gyros 14 are mounted on the top side and four gyros 14 are mounted on the bottom side of the selected axis panel 43. The four top-side sensors 14 are arranged around a central point in the selected axis panel 43. Each top side sensor 14 is adjacent two other sensors 14 and oriented at 90 degrees to each adjacent sensor 14. Each bottom side gyro sensor array 42 is oriented such that their sensitive axes are mirror images. One panel contains the DSP 44.

The top and bottom mounted gyro embodiment causes a significant reduction in gravitational-pull-induced noise sensitivity detected by the MEMS gyro sensors. Such a reduction is critical in measuring 3D motion to obtain an angular rate, acceleration, and position data in real time. This embodiment 40 comprising one eight-member gyro array 42 on one panel 43 yielded a noise improvement factor of 2.8. The usage of extended Kalman filter computations further improved the noise performance by a factor of >20.

FIG. 8 shows another embodiment 50 of the device for achieving further optimization of the IMU's gyro performance. The usage of more than one eight-member array would require that the 3D fully integrated device would have to be made larger to accommodate the additional gyros 14. Moreover, the cost per unit would increase and there would be less protection from high shock transients. Substituting the eight-member gyro array 42 described above in one of the axis panels 43 and then using virtual gyro algorithms further enhances the beneficial effect provided by the sole array. The substitution of an eight-member gyro array 42 for one of the single MEMS gyros 14 located on one of the panels 43 coupled with an enhanced Kalman filter and virtual gyro algorithm 45 is a unique approach to cost effectively optimize the performance of the micro-MEMS IMU. To achieve this effect, a virtual gyro algorithm 45 is combined in a multistage Kalman filter solution for providing an improved solution for gyro performance and hence IMU performance.

FIG. 8 includes the algorithm sections that make up the Kalman filter solution. The hardware layout scheme to achieve “virtual gyro-hardware” as described above is used to reduce the drift and dc errors of the MEMS gyros by combining groups of four on each side of the board layout to reduce these errors significantly either by analog summation techniques before digitization or direct digitalization of all the gyros and digital processing, including summation and filtering.

The “virtual gyro” algorithm techniques are used to extend performance. Here, an optimal filter combines and smoothes multiple gyro measurements to produce a minimum-variance rate estimate. This rate estimate is denoted as a “virtual gyro” since it is indistinguishable from an actual rate measurement taken from a single physical gyro having improved performance. A 1-2 order of magnitude improvement in drift is achieved, enabling the achievement of tactical-grade performance and usefulness of the device in a wider range of applications than currently available.

The other sensor inputs are also combined in the Kalman filter, that is, accelerometers 46 and GPS 21, temperature sensor 30, and magnetometer 47 data, to compute an improved solution.

The virtual gyro algorithm processes the outputs of multiple gyroscopes to increase the accuracy of rate (that is, angular velocity) readings. This method is intended especially for application to gyroscopes that are parts of micro-electromechanical systems (MEMS). The method is based on the concept that the collective performance of multiple, relatively inexpensive, nominally identical devices can be better than that of one of the devices considered by itself. This method makes it possible to synthesize the readings of a single, more accurate gyroscope (a “virtual gyroscope”) from the outputs of a large number of microscopic. A 27-state Kalman filter was created as part of a statistical analysis effort to determine how good the virtual gyro and accelerometers could be in a GPS-based Kalman filter solution for UAV flight profiles. This analysis provided results that favor the virtual gyro approach. For this solution (FIG. 8), the navigation system algorithm solution comprises three components: the IMUs provide raw accelerations and rotations in body frame (gyro sensors); the pure inertial navigation system resolves the inertial measurements in navigation frame and updates the attitude, heading, velocity and position of the module; and the Kalman filter 48 integrates the measurement of the pure inertial system with the measurement of external sensors to provide corrections to inertial system errors.

For the “virtual gyro” solution, an attitude reference 27-state Kalman filter is enhanced to process the virtual algorithm solution from the array of gyros placed in the hardware (virtual gyro-hardware) to reduce dc errors as well as process the virtual gyros that are presented as independent gyro inputs digitized and input to the Kalman filter for processing. By taking advantage of both the hardware and algorithm improvements, performance improvements are achieved using off-the-shelf MEMS devices.

The 27-state Kalman filter refers to a dynamic state-space implementation of the filter. In one improved embodiment of the invention, the implementation will be in the form of a Sigma Point Kalman Filter that may use more or fewer than 27 states.

The attitude determination algorithm is divided into two separate entities. Gyro-measured angular rate information is integrated in time in the attitude processor. If the initial attitude of the vehicle were known, and if the gyros provided perfect readings, then the attitude processor would suffice. However, the initial attitude is seldom known, and gyros typically provide imprecise data due to bias drift and turn-on instability. Both gyros and accelerometers have bias and bias drift terms and suffer from misalignment errors, acceleration errors (G-sensitive), nonlinear (square term), and scale factor errors. The largest error is typically associated with the bias terms. Without a filter structure and separate independent measurements, the attitude processor would diverge from the true trajectory. The Kalman filter attitude correction component therefore provides an on-the-fly calibration by providing corrections to the attitude processor trajectory and a characterization of the gyro bias state. The accelerometers provide an attitude reference using gravity. A 27-state Kalman filter simulation study has shown good results and is the basis for this approach.

A known method of virtual gyro computation uses a method of combining and filtering the digitized outputs of multiple gyroscopes to obtain minimum-variance estimates of rate. In the combining-and-filtering operations, measurement data from the gyroscopes are weighted and smoothed with respect to each other according to the gain matrix of a minimum-variance filter. Since it is well known that errors for multiple gyros behave in predictable ways, the minimum-variance gain matrix is analyzed and a simple algebraic method developed for computing the optimal gain matrix.

For statistically independent gyros, it has been shown that component drifts add like parallel resistors in terms of their variances (e.g., in units of rad²/sec³). For example, the drift of a virtual gyro composed of N independent and identical devices will be 1/N of the individual device variance (e.g., like N resistors R in parallel having overall resistance R/N). Note that this corresponds to 1/N^{1/2} of the individual device drift in units of rad/sec^{3/2}.

Any individual device with a large drift will not count much in the overall performance (like a large resistor in parallel, which can usually be removed from consideration). Any device having drift significantly less than the other devices will dominate the performance of the virtual gyro (like a small resistance in parallel).

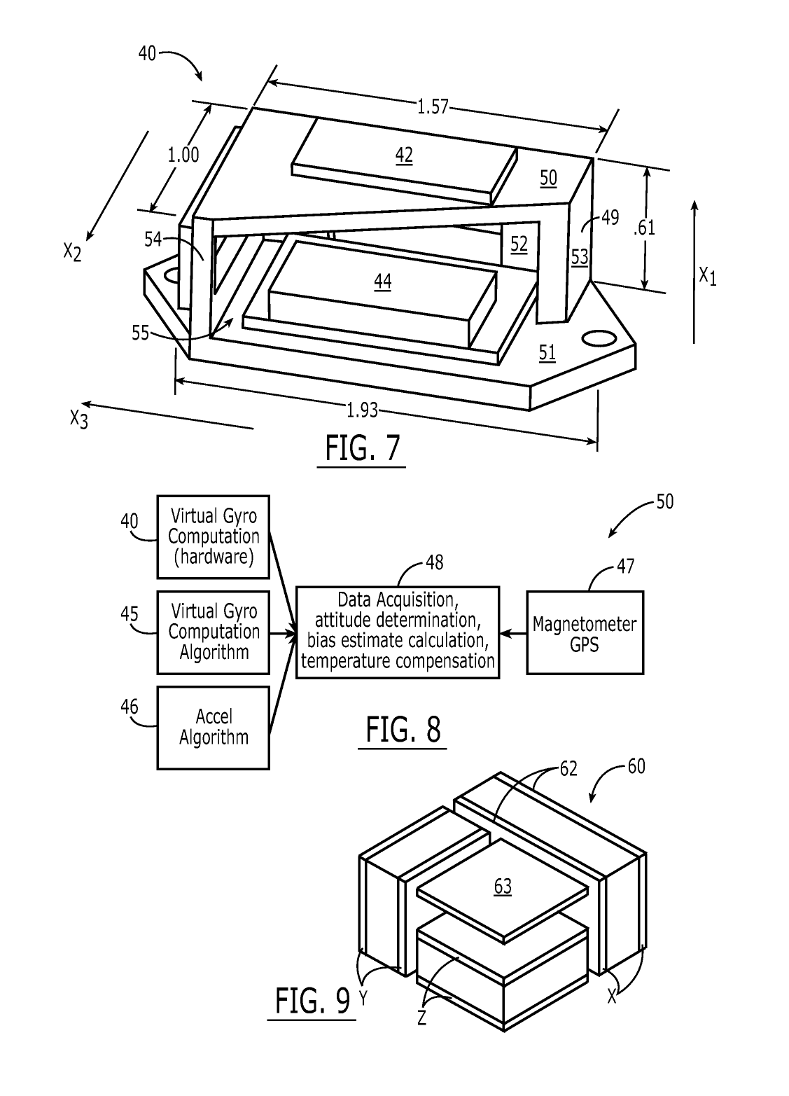

Referring to FIG. 7, one embodiment of a fully assembled device 40 comprises a miniature 3D structure comprising the operating system member 44 and a metal support member 49 wherein the operating system member 44 is protected from shock and high-G environments. The metal support member comprises a four-sided rectangular cube having a top 50, bottom 51, back 52, and right 53 and left 54 sides. A rectangular portion is cut from each side to provide four rectangular cut-outs 55.

Assembly is achieved by placing the flex board member within the metal support member 49 with flex board panel positioned against the bottom 51 and then fitting all four panels into their respective adjacent rectangular cut-out 55. The properly oriented panels are then bonded into place.

The above two embodiments 10,40 do not specifically refer to the inclusion of a magnetometer in the device, although FIG. 3 shows that the device can include a magnetometer input 22. Any magnetometer 22 should be mounted outside the metal support member to avoid interference of magnetic measurements by the magnetometer and can be mounted under the bottom 51 of the device 40 depicted in FIG. 7.

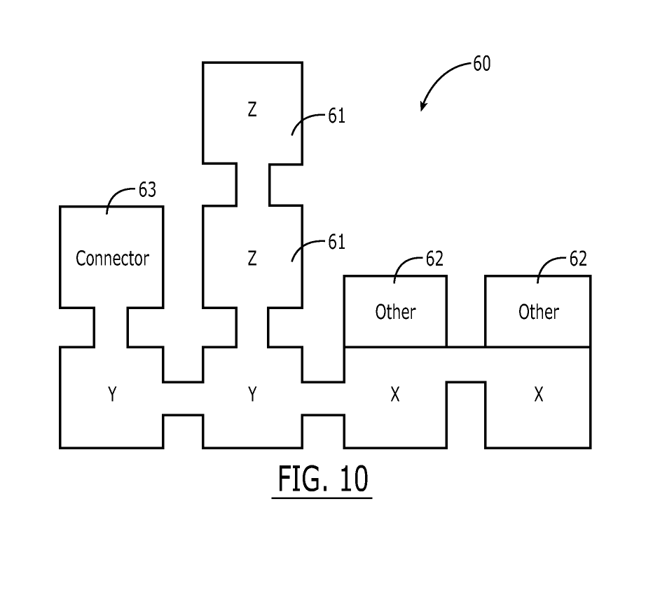

The mechanical configuration need not be in the frame design described. To accommodate other designs requiring more panels, an alternate configuration 60 is shown in FIG. 10. The modules are then folded as illustrated with reference to FIG. 9. In FIG. 10, two panels 61 per axis are used to house the multiple gyros (virtual gyros) and the multiple ADCs needed to digitize all the inputs and process them in the DSP in the panels 62 marked “Other.” More than eight gyros per axis can be accommodated using multiple panels per axis. Note that substantially all the volume is used, which is the reason for the two X boards being longer than the others. The total volume may be as small as approximately 1.41 in³. The connector 63 is used to both program and load the code into the DSP as well as read out the IMU performance parameters. The entire assembly may be potted for ruggedness, only allowing the top surface (to which the connector is mounted) free. An internal fixture can hold the modules square during potting.

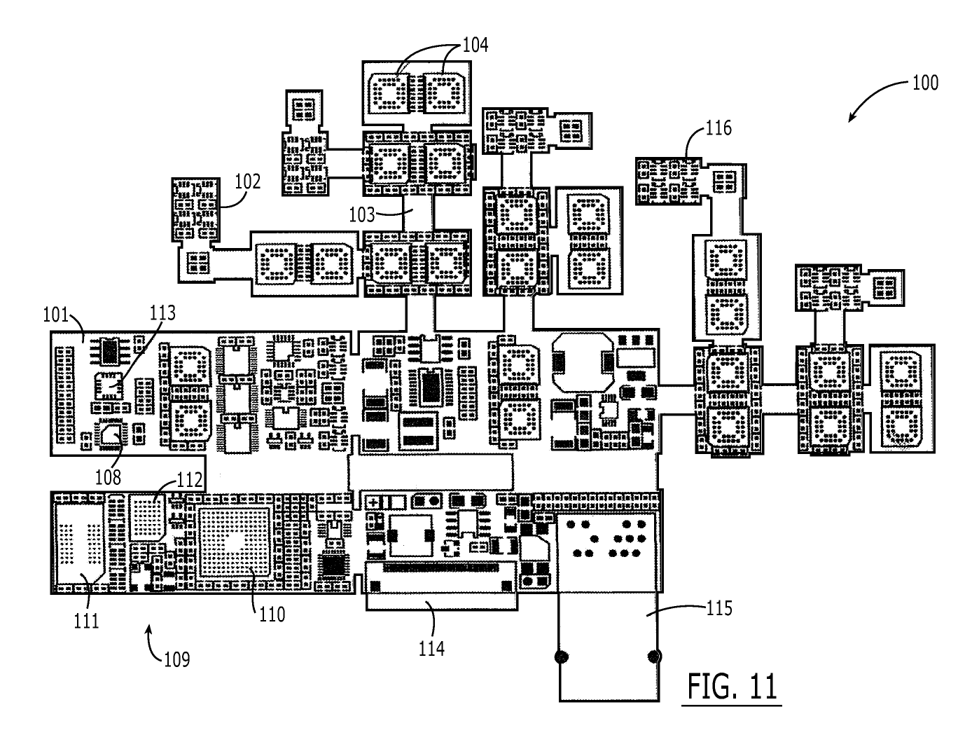

Another embodiment 100 of the present invention is illustrated in FIGS. 11-19. This embodiment of an inertial measurement unit can provide near-navigation-grade performance with commercially available off-the-shelf components. FIG. 11 is a top plan view of a semi-rigid flex board layout of the device, illustrating the active components positioned on a unitary, substantially planar base 101. The base 101 comprises a plurality of sectors, each sector comprising a PCB panel 102 linked together with flexible connectors 103, the panels 102 foldable relative to each other. In the embodiment shown, there are 24 panels 102. The arrangement confers shock-hardening to the structure, in excess of 20,000 Gs.

This embodiment 100 comprises a total of eight gyros 104 per axis, for a total of 24, positioned two to a panel 102. Preferably the gyros 104 comprise micro-electro-mechanical system (MEMS) gyros, although this is not intended as a limitation, with exemplary devices comprising Analog Devices ADXL610 MEMS gyros, and it is believed that nanoscale devices are also usable for the present application.

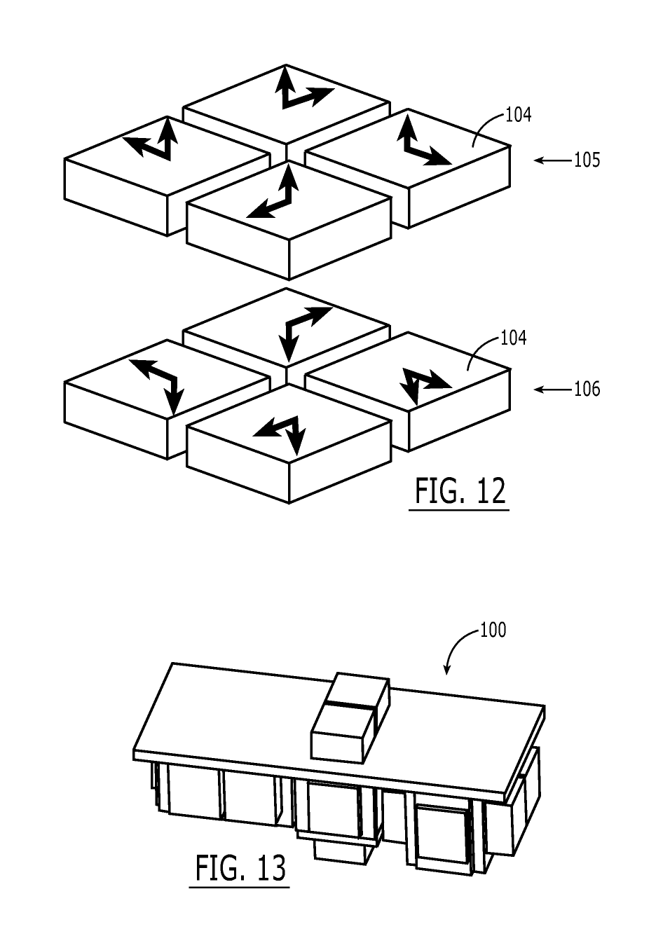

When folded, the panels 102 achieve an orientational layout as depicted schematically in FIG. 12. Here, N=4 gyroscopes 104 are oriented at 360/N-degree (i.e., 90°) increments in the top set 105 in a first direction, and another set of N=4 gyroscopes 104 are oriented at 90° increments in the bottom set 106, positioned in a second direction opposite the first direction (i.e., inverted, or “upside down”). This orientational layout is repeated to achieve the same structure for all three x,y,z axes, and has been shown to reduce dc error terms, specifically G and G² drift errors, by forming a “virtual gyro.” In a particular embodiment, the panel 102 holding one set of four gyros 104 is positioned atop and inverted relative to its companion panel 102 of four gyros 104.

Also positioned on the base 101 is at least one triaxial accelerometer 107. Similarly to the virtual gyro as described above, a virtual accelerometer array can be formed using multiple triaxial devices or multiple individual accelerometers to form an array, each of the devices positioned in 90° increments. An exemplary accelerometer 107 usable for the present application comprises an Analog Devices ADXL330 device, which comprises a small, thin, low-power complete three-axis accelerometer with signal-conditioned voltage outputs on a unitary, monolithic integrated circuit. This device measures acceleration with a full-scale range of ±4 G. The typical noise floor is 170 μG/root Hz for x and y axes, and 350 μG/root Hz for z axis, allowing signals below 3 mG to be resolved in tilt-sensing applications using narrow bandwidths between 0.5 and 60 Hz. The output temperature sensitivity or change between ambient and either maximum or minimum temperature is 0.01%/° C., while the zero offset G errors with temperature vary only 1 mG/° C.

The array can comprise devices arranged in an active x-y plane with a z plane through the top of each chip 107. Another array turned upside down is then formed similarly, again with a minimum of four devices. This layout also reduces dc error terms by canceling errors common to the individual sensors. Such a “virtual sensor” arrangement achieves improved accuracy to reach an accuracy of 1 milliradian in the azimuth orientation.

A three-axis magnetometer (magnetic sensor) 108 is also positioned on the base 101 for reporting true north and also for eliminating local magnetic anomalies and effects.

Temperature sensors 121 in a particular embodiment are part of each of the gyros 104 and accelerometer 107. The temperature sensors 121 sense temperature and compensate for changes outside the normal gyro and accelerometer ranges.

A processor 109 is also affixed to the base 101 and, in a preferred embodiment, comprises a digital signal processor (DSP) 110 that is capable of adapting to computational load to reduce current consumption and minimize power usage. Support is provided by a 32-MB SDRAM 111, a 3-MB flash 112, and a 128-kB EEPROM 113 device. A 40-pin connector 114 having a plurality of buses is affixed to the base 101, as are integrated magnetics and a J45 connector 115. The buses can include, for example, CAN, UART, Ethernet, SPORT, SPI, and JTAG communications, although this is not intended as a limitation. External power can be provided by two ports, including, but not intended to be limited to, 5.5 V dc and/or 7.0-24 V dc. Alternatively, the unit 100 can be powered by a power-over-Ethernet (POE) connection. Electrical conversion is provided by analog-to-digital devices 116 in communication with the gyros 104.

The elements of the device 100 are contained in a structure that, when folded, has a volume less than 1.9 in³. An exemplary layout is depicted in FIG. 13, which shows the panels 102 folded to form a three-dimensional structure having the dimensions 2.2×1.012×0.83 in. The structure achieves the necessary alignment by a two-step fabrication and assembly process. In the first step, the single-sided flex circuit is folded, bonded to an internal structural element, and potted to form a flex circuit with three gyro modules. In this process a fixture may be used to align the gyros in each direction with one another.

In the second step, the alignment of one gyro module to the others is achieved, in which a second internal structure holds the modules square to one another to a great degree of precision.

In another embodiment of the fabrication process, the gyros can be aligned grossly upon mechanical assembly, and adjustments made with software processes. In this method the assembly is placed on a rotating table, and the output of each individual gyro is examined. Any output of an off-axis gyro is deemed due to misalignment and the misalignment angle inferred. The misalignment can then be corrected by performing vector processing on the array of device outputs.

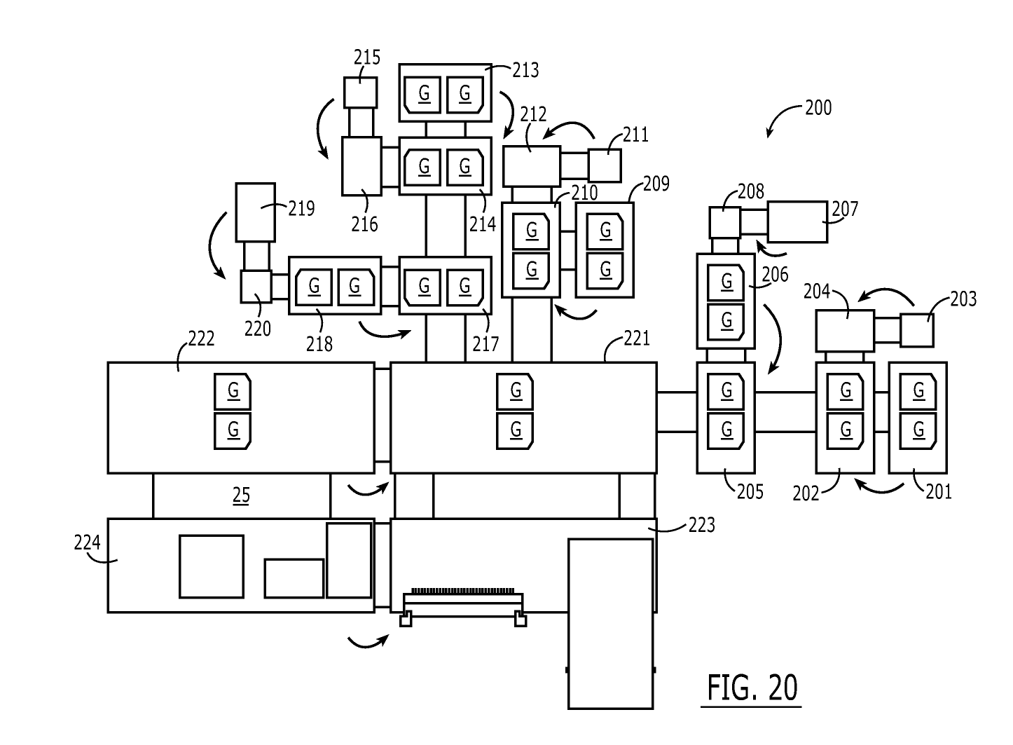

FIGS. 20-25 schematically illustrate steps in achieving final assembly, which requires a populated flex circuit, three gyro mounting tubes, double-back tape, adhesive, potting material, several fixtures, and a mold. One of skill in the art will recognize that other fabrication processes may be envisioned, and the particular steps in preparing the device are not intended to be limiting.

In a particular embodiment, the flex circuit 200 comprises 24 boards 201-224 arranged in 12 pairs (FIG. 20), connected with flexible connector material 225 as shown. The tape is cut to obtain 12 matching pieces. The tape is applied to the second of each pair and the release paper removed, and the second board is folded over and onto the first, as shown by the arrows. Then the second board is aligned to the first using a fixture. This step is repeated for each of the remaining pairs.

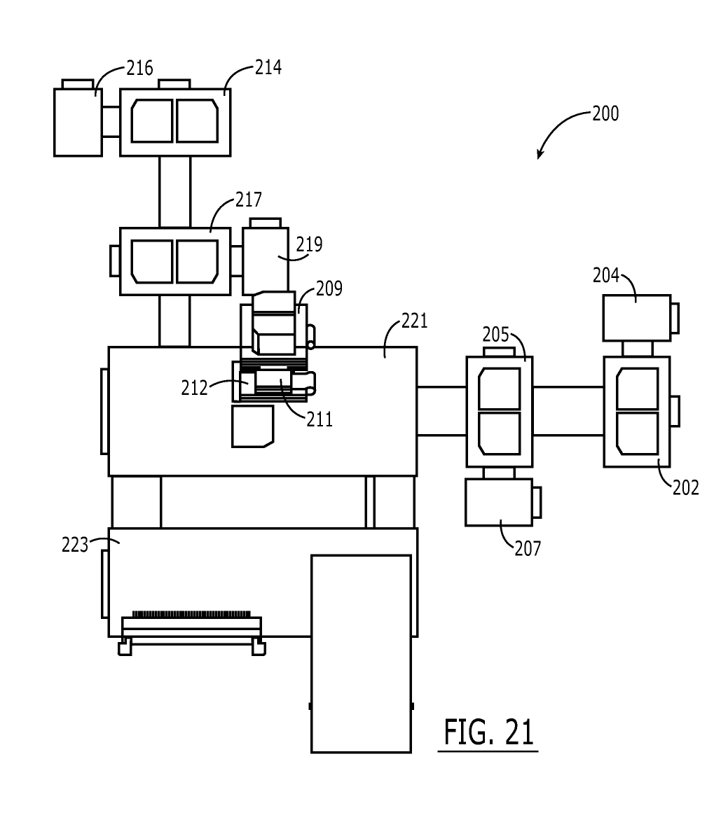

In order to illustrate this for one of the sets of circuit boards, refer to the set of circuit boards 201-204 in FIG. 20. Board 201 is folded under board 202 so that the respective gyros G mounted thereon are on the outsides of a formed “sandwich.” Board 203 is folded under board 204 to form another layered structure. This is repeated for the other four similar sets of boards 205-208,209-212,213-216,217-220. The other four gyros G to make up the sixth set are on boards 221,222, which are also folded together with board 222 beneath board 221. The other two boards 223,224 are also folded with board 224 folded under board 223. Boards 222,224 and 221,223 are also connected together with flexible connector material 225. The result of these steps is shown in FIG. 21.

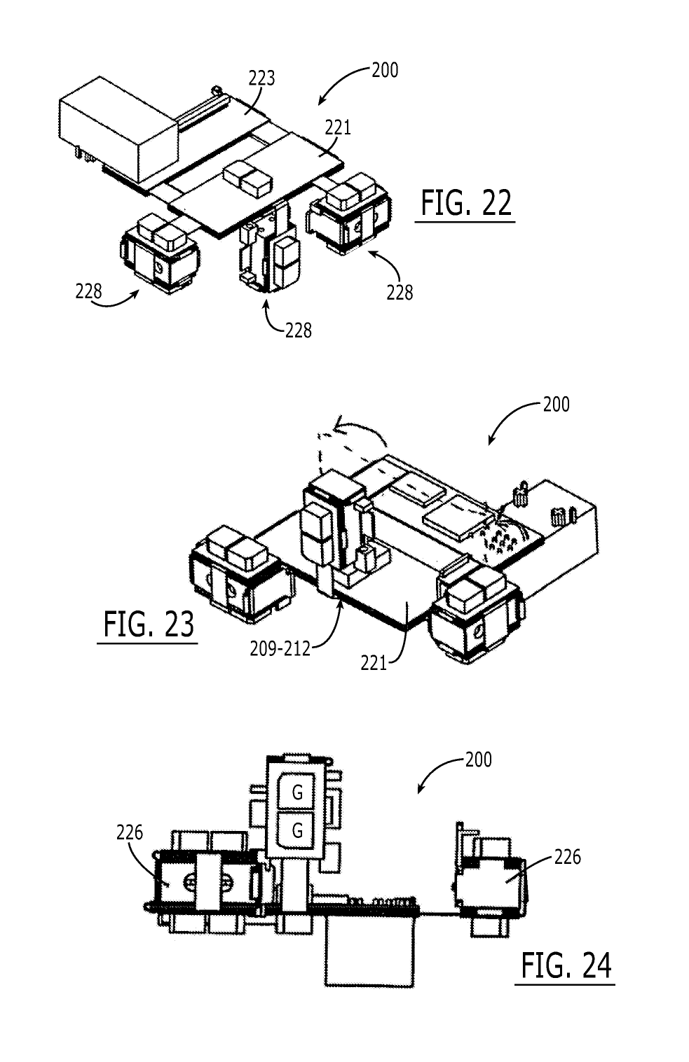

Next the gyro modules are assembled. Using the appropriate fixture and mounting tube, the gyro and support boards are wrapped around, as shown for boards 209-212 in FIG. 21. Here, board 210 is in position beneath board 209. Next each of the assembled gyro units, as shown in folded configuration in FIG. 22, is folded onto board 221, as shown in process in FIG. 23, wherein gyro unit 209-212 is positioned atop board 221, as in FIG. 21. Note that the remaining gyro set on boards 221,222 are positioned “upside down” from each other owing to the folding of the boards on which they reside, and that the gyros G on board 221 are surrounded by the unit formed by boards 209-212.

Next the gyro units are bonded to the appropriate mounting tube 226 (FIG. 24). The purpose of the fixture 226, which may comprise, for example, a generally rectangular box-like structure, is to align the gyro boards to one another. The interior of the gyro modules is potted by injecting potting material through holes in the tubes 226. These steps are repeated for the other two modules.

The final fold up proceeds by folding a side module that comprises boards 223,224 into an approximate position normal to boards 221,222, as shown by the dotted lines and arrows in FIG. 23. A tab on the side module 223,224 is slipped into a slot in the center module. The tab is moved down the slot, thereby engaging the hook on the tab. A setscrew is tightened, thereby fastening the side module into position relative to the center module 221,222. These steps are repeated for the other side module.

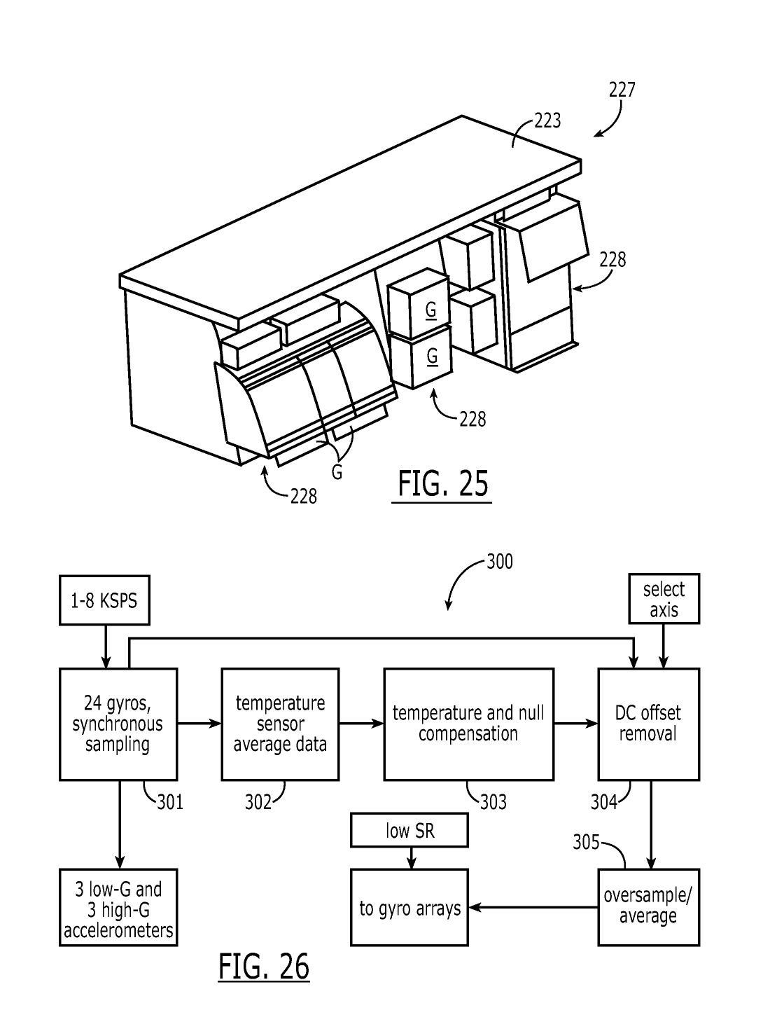

The assembly 227 shown in FIG. 25 is then placed into a mold and the mold filled with potting material.

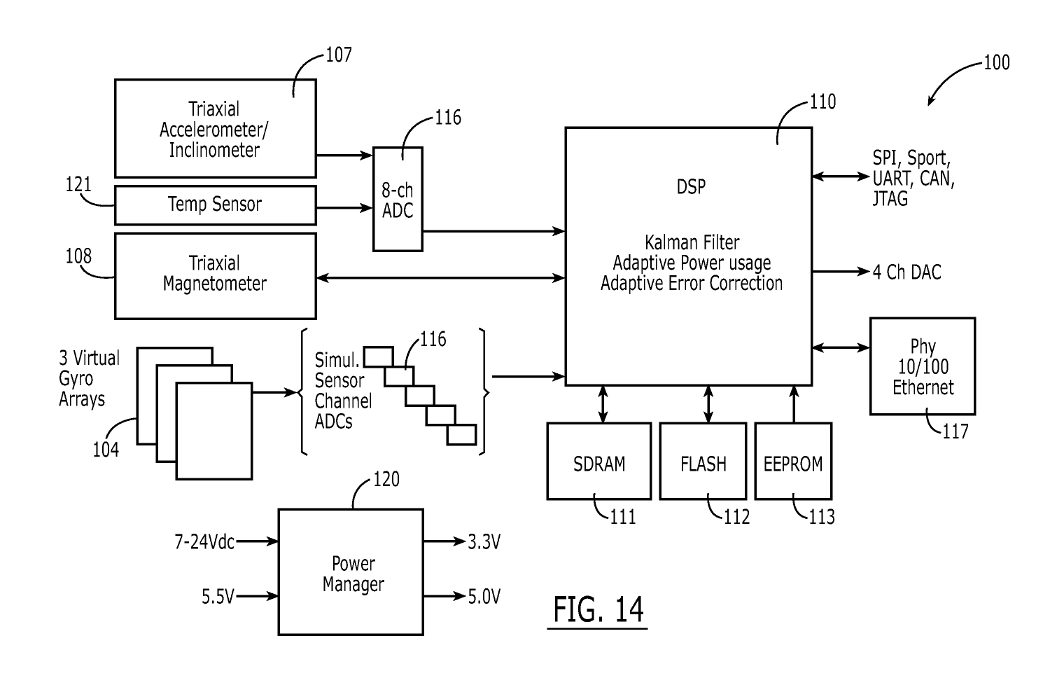

The computational portion of the invention is shown in block diagram form in FIGS. 14-17, in which optimum performance is achieved by the integration of the sensor arrays to correct bias errors inherent in MEMS technology using “virtual sensor” technology. As discussed above, each axis contains eight gyros 104, a single MEMS triaxial accelerometer 107, and three micro-packaged analog-to-digital (ADC) converter devices 116 that integrate with the processor 109 bus in a manner believed optimum to reduce analog errors and execute the algorithms in the DSP 110. Temperature compensation is implemented in the DSP 110 as well.

An exemplary electronics layout is given in FIG. 14. Several output bus options are available, including, but not intended to be limited to, RS232 and 10/100 Ethernet 117. Either bus can be used to download and run real-time code in the DSP 110. The software can implement the algorithm in fixed-point, block floating, or floating-point notation. The power manager circuit 120 creates regulated 3.3- and 5-volt inputs to all internal circuitry requiring either or both dc voltages.

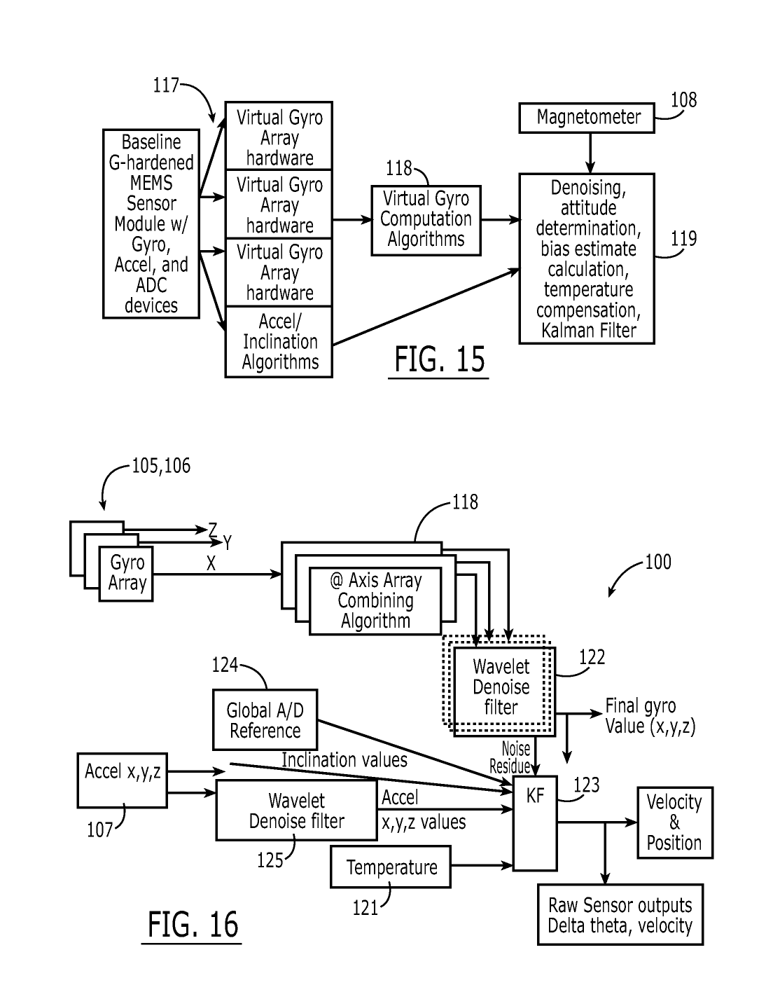

Exemplary computation methods will now be discussed with reference to FIGS. 14-19. An overview flow diagram of the algorithm is given in FIG. 15, wherein output 117 from the sensors 104,107 in an array are subjected to the virtual gyro computation algorithms 118 of the present invention. The resulting data and magnetometer input are then processed 119 by a denoising algorithm, attitude determination, bias estimate calculation, temperature compensation, and a Kalman filter 123.

More detail on the computations of the present invention will now be discussed with reference to FIGS. 16-19, the computations designed to improve accuracy by reducing inherent errors in the hardware and output thereof. There are several sources of error in inertial measurement units (IMUs). To obtain position, one triaxial accelerometer can measure the total acceleration vector of a body relative to inertial space. This acceleration vector can be converted from body coordinates to earth coordinates using the known instantaneous orientation of the body determined by the gyros. Position is then obtained by subtracting off the effect of gravity from the measured acceleration and then performing double integration starting from a known inertial position. Drift in the determination of orientation results mostly from gyro biases, defined as the output produced by a gyro at rest. Fixed biases, if uncompensated, lead to a constant rate of drift after integration. The most important issue, however, is bias stability. MEMS gyros have drift rates ranging from several degrees per hour to a degree per second.

Accelerometer instrument errors also occur, such as bias stability, scale factor stability, nonlinearity, and misalignment. Tactical-grade accelerometers must keep these errors to a few micro-G. Since position is obtained by double integration of acceleration, a fixed accelerometer bias error results in a position drift error, which grows quadradically in time. It is therefore critical to accurately estimate and eliminate persistent bias errors.

Another cause of error in position measurement is error in the orientation determined by the gyros. Since the device interprets the direction of the measured acceleration according to the computed orientation of the platform, any error in this computed orientation causes it to integrate the accelerometers in the wrong direction, thus deviating slightly from the true course of the vehicle. The cancellation of gravity is performed imperfectly in the DSP, causing a horizontal acceleration, that is, an error in angle, to be erroneously added to the earth-frame acceleration vector. Thus the pitch and roll accuracy must be better than 0.005 degrees for the duration of a flight, which sets a more difficult standard for the gyros than the accelerometers.

The hardware and software of the present invention significantly improve the performance of a single gyro per axis by combining multiple devices using both hardware alignment techniques and a combination of algorithms processed in the embedded DSP (FIG. 16). Here the data from the gyro array 105,106, containing x,y,z information, are sent to an array-combining algorithm 118, and thence to a wavelet denoising filter 122. The wavelet-based cascade denoising filter 122 is used to improve the sensors' signal-to-noise ratios and to remove sensor errors mixed with motion dynamics. It reconstructs the gyro signals with improved signal-to-noise ratio in one channel while providing the variance characteristics of the noise in a second channel, both for further processing by a Kalman filter (KF) 123. The Kalman filter 123 also receives input from a global ND reference 124, a temperature sensor 121, and accelerometer 107 by way of a wavelet denoising filter 125.

The proposed method has been applied to a MEMS-based IMU containing an array of Analog Devices MEMS gyroscopes and an ADI triaxial MEMS accelerometer. Previous results using single gyros and accelerometer devices per axis have shown that an enhancement in positioning accuracy by at least 50% during GPS outages can be obtained by applying a specific type of wavelet filter, thus reaching positioning accuracy levels equivalent to those of some of the current tactical-grade systems but at a much lower cost.

Several different forms of wavelet denoising algorithms have been evaluated for this application. The cascade wavelet denoising algorithm has been selected because the number of cascade levels can be used to control both the amount of noise reduction and the amount of real signal content that is allowed to be recovered during the filter process.

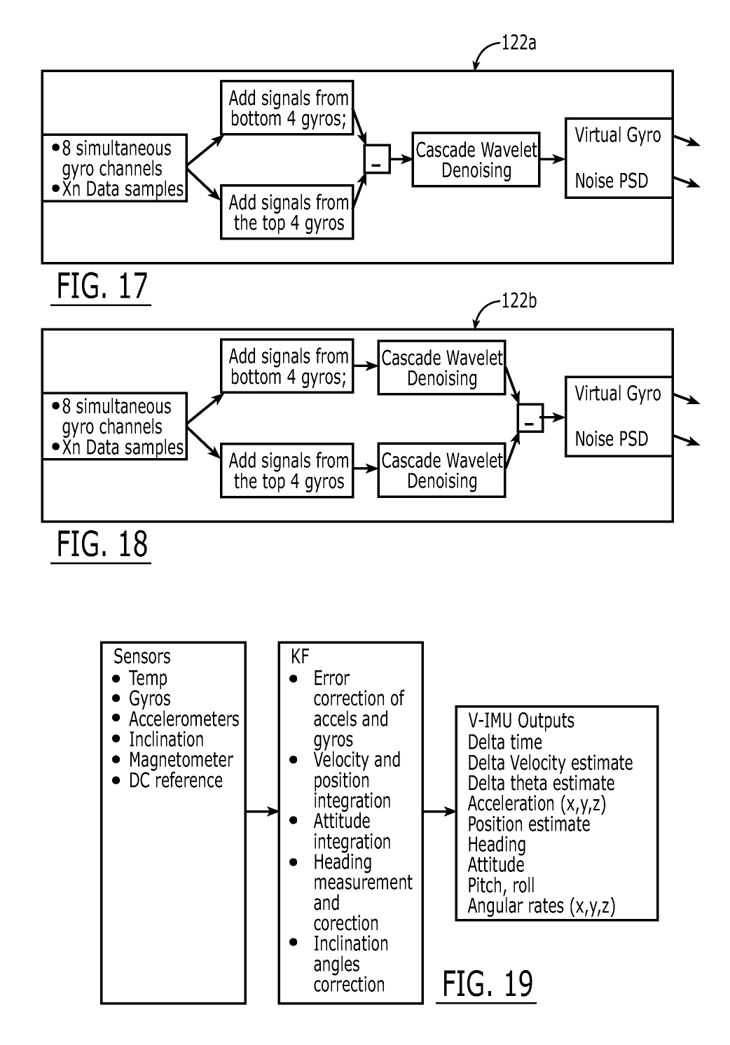

To take advantage of the denoising algorithms 122 for gyro arrays, two exemplary arrangements (FIGS. 17 and 18) have been described for each axis. Although any of the conventional denoising, the cascade denoising solution, or the array denoising solution can be selected, the cascade solution has slightly more performance and control and at the expense of more computational requirements than the conventional version, but less computational requirements than the array version. The final arrangement can be dependent on the computational capacity of the processor, since one approach uses twice as many wavelet algorithm computations as the other. For the hardware implementation, the cascade algorithm has been selected to maintain better control of the final angular rate sensor outputs.

One embodiment of the algorithm includes summing the top four gyros, summing the bottom four gyros, and subtracting one summed signal from the other summed signal. The denoising algorithm is applied after the mathematical sequence. In another embodiment of the algorithm, two denoising algorithms are used, one on each summed array. Then one denoised summed array is subtracted from the other.

With reference to FIGS. 17 and 18, and by way of example, two different forms of wavelet denoising algorithms 122a, 122b are described for denoising the array of gyros in each axis. One is referred to as conventional denoising, and the other is a modification called the cascade algorithm. Both algorithms basically perform the wavelet transform, threshold the transform coefficients, and perform the inverse transform. The cascade algorithm has a slightly different threshold from the conventional case, and some additional low-pass filtering. In both algorithms the wavelet transform is initially performed. A matrix is created that represents the wavelet transform, and the matrix is multiplied by the input signal. This matrix method is an efficient approach and works well. However, the matrix needed is N×N, where N is the length of the input signal. Therefore, this approach might use excessive memory if long input signals are used. If memory is an issue, the wavelet transform can be computed using a different approach such as with filtering commands. Both algorithms are restricted to performing five levels of the wavelet transform.

In the conventional denoising approach, noise is assumed to be additive white Gaussian. The variance of the noise is estimated from the median value of the wavelet coefficients at the first scale. Then, a threshold is determined that is based on normalizing the noise distribution. There are documents in the literature on how to choose the best threshold, or identify noisy coefficients. Regardless of how the wavelet coefficients are thresholded, the inverse wavelet transform is then performed, and the resulting signal is the denoised signal. The largest difference between the cascade and conventional algorithm is that the cascade algorithm low-pass filters the data with wavelet filters before thresholding. This method is implemented using the following approach. After the wavelet transform is calculated and thresholded as in the conventional case, wavelet coefficients in the first L levels are set to zero before the inverse transform is performed. In addition, the cascade algorithm uses a slightly different threshold than the conventional case. Its threshold behaves in between that of a hard and soft threshold.

A third exemplary denoising algorithm has the form of an integrated array solution: The method works on an array of input vectors that are highly correlated with the same or differing signal-to-noise ratio. A representative vector of the array is found and denoised. The denoised vector is thresholded and multiplied by each signal in the array. Therefore, samples set to zero in the denoised vector are set to zero in all input signals. Samples allowed to pass in the denoised vector are allowed to pass in the input signals. In this way all input signals are denoised. Then the top array of denoised vectors is summed and subtracted from the sum of the bottom array.

With regard to further improvements, the wavelet filter de-noising process earlier described is desirably replaced with a morphological-filter algorithm that reduces transient noise without imposition of an unnecessary reduction of bandwidth or increase of latency.

An exemplary embodiment of the V-IMU of the present invention denoises the angular rate sensor signals once per set of gyros per array to find the actual pitch, roll, and yaw angles. The V-IMU uses the accelerometers to correct for rate sensor drift in the vertical angles (pitch and roll); the V-IMU uses the magnetometers to correct for rate sensor drift in the yaw angle. The IMU takes advantage of the rate gyros' sensitivity to quick motions to maintain an accurate orientation when accelerations would otherwise throw off the accelerometers measurement of the IMU orientation relative to gravity; the IMU then uses the accelerometers to provide long-term stability to keep the rate gyro drift in check.

A complementary Kalman filter estimates orientation, gyroscope offset, and magnetic disturbance by combining 3D gyroscope, accelerometer, and magnetometer signals using relevant signals (see FIG. 19). Both accelerometer and gyroscope signals are used to make an estimate of the inclination z. The direction of the global magnetic vector H is estimated by the gyroscopes and magnetometers. It is assumed that the magnetometer can compensate for local magnetic disturbances. As long as the disturbance is within a specified boundary, the new magnetic field vector can be used as a reference.

The Kalman filter and an output of the filter are connected to the measurement system to provide a correction signal for correction of gyro bias errors, the accelerometer errors, and the temperature derived from an internal temperature sensor to measure and correct for temperature extremes.

Error detection and test and compensation functions are embedded into the V-IMU hardware, and are connected to and controlled by the DSP firmware. Via a serial multichannel ADC, an accurate temperature sensor measures temperature of the sensor array to extend the temperature range operation of the gyros and accelerometer(s) beyond −40 to +105° C. A single voltage reference signal that is the ratiometric reference for the gyros is used as a single voltage reference for all gyros and accelerometers, and is used as the digital reference for both the wideband orthogonal digitized accelerometer inputs as well as the orthogonal inclination values. To test the improved performance of the “virtual accelerometer” design, a tiny array of accelerometers can be designed in an external module and the three virtual triaxial channels read into the V-IMU through three optional input ADC channels. The DSP algorithms cancel out the dc errors in the same way as implemented for the gyros.

To verify the proper operation of each individual gyro or 4×4 gyro subarray or 8×8 gyro array for each axis, each gyro is simultaneously digitized and stored in the DSP. Each signal can be processed separately or as a sub- or complete array per axis to sample performance, noise floor, or the average value of a set of gyros. The DSP initiates the self-test (ST) function for each gyro and each accelerometer axis. A continuous self-test mode does not affect the average output value of each sensor. Due to the complementary nature of the self-test function, any residue of the self-test signal at the output filter is minimized when the two self-test inputs are actuated sequentially. Using this feature, the output of each gyro can be adjusted for a given signal input level (G measurement). The output noise for each sensor as well as the sensor array can be measured and the cascade wavelet denoising filter parameters can be set based on these data. Finally, the denoising noise variances can be computed and used for setting the appropriate Kalman filter parameters throughout the hours of operation required by the mission. Finally, a Kalman filter reduces the errors further and computes accurate data of the types shown in FIG. 19.

In general, the higher the internal sampling rate and the bandwidth of the inertial sensors, the better the dynamic performance of the inertial measurement system. The proper internal data synchronization is also very important for accurate signal processing if the system is operated under a difficult dynamic environment. A high-precision internal time reference therefore is very important to be available inside of the IMU. The V-IMU operates with a high sample rate and sets wide sensor bandwidths. All gyro conversions are simultaneously sampled, and the accelerometer is sampled at high rates. The accurate time reference is set by the internal DSP clock.

The V-IMU uses a sophisticated Kalman filter to track the bias in the rate sensors after most dc errors have been eliminated using the gyro array and cascade wavelet filter. This makes the V-IMU very accurate in dynamic maneuvers.

The Kalman filter provides an on-the-fly calibration by providing a real-time characterization of the gyro bias state. The accelerometers provide an attitude reference using gravity and the triaxial magnetometer senses true North while compensating for magnetic metals close to the sensor location. These two sensors provide accurate and stable estimates of Euler roll, pitch, and heading angles.

The algorithm for blending the magnetometer attitude solution with the inertial attitude solution in real-time samples the output from the three gyro arrays at 1 to 10 kHz. The output from the gyros is numerically integrated to provide an estimate (time update) of the three Euler angles. A Kalman filter is used to blend the magnetometer/accelerometer inclination measurement attitude solution with the estimates obtained by straight integration of the gyros. This measurement is updated if GPS is present to error correct the remaining gyro drift rates.

A method for heading determination is described here that includes the effects of pitch, roll, and yaw as well as the magnetic properties of the module. Using solid-state magnetic sensors and a three-axis inclination sensor, a low-cost compass system functions within the V-IMU module.

The magnetic sensor can have significant distortions in the heading output provided by the compass due to its close proximity to the other sensors and the electronics and the metal frame used to mount and align the sensors to the three axes of reference, and thus calibration requires a substantial effort. Besides the constant magnetic declination, the compass is affected by local distortions of Earth's magnetic field. With a non-ferrous mechanical turntable used in initial calibration of the module, it is possible to measure these errors. The distortions can have peak-to-peak values of about 2 deg.

Unfortunately, it is difficult to build a working mobile platform that does not place some sources of magnetic distortion in the general vicinity of the compass. In the real system, compass errors can have peak-to-peak values of 5 degrees. The magnetic compass selected has an internal calibration procedure, which can take into account a static distortion of magnetic field. For dynamic distortions the compass provides an alarm signal, which is active when such error occurs, and then the compass measurement can be ignored and computations rely only on the gyro array.

The bias of the gyroscope array can be measured for each axis by averaging several minutes of output while the gyros are kept still. For scale, the specified values in the manufacturer's test sheets are used for each gyro. Using the initial calibration data for the inertial sensor assembly (bias, linear scale factors, gyroscopes triad non-orthogonality) measured for each module, the inertial sensors are validated. Important measurements include: the evaluation of the noise of the inertial data sets, static gyro calibrations to determine the supplementary nonlinear terms of the static transfer characteristics, considered only to degree 2, as well as the establishment of the nonlinear time and temperature behavior of the gyro's drift and scale factors and the non-orthogonality of the gyro's triad.

Since gyro outputs can change quickly in response to test setup specifications, gyros can be sampled at 1000 Hz. In contrast, the compass responds slowly and is read at 16 Hz over a serial line. Therefore, when compass and gyro inputs are read simultaneously, there is some unknown difference in the times of the physical events they each represent. It is possible to determine the relative latency by integrating the gyro outputs and comparing with compass readouts by shifting one datum in time until they best match. The relative latency is taken into account by attaching to each sensor readout a time tag. This is taken into account in the fusion step.

The individual nature of GPS and INS systems are complementary. GPS provides accurate position and velocity information that do not drift over time. A major limitation of GPS is that the output data rate is not sufficient for many applications. An INS system can provide attitude, position, and velocity information at extremely high data rates. A major disadvantage is that these measurements are subject to large errors if not aided by some external source, such as GPS. Thus, an integrated GPS/INS system can provide a user with highly accurate attitude, position, and velocity information at very high data rates.

There are principally two ways GPS and INS data can be combined. They are commonly known as loosely and tightly coupled systems. In a loosely coupled system, two processes must be performed sequentially. First, the GPS data must be processed by its own Kalman filter. The output position and velocity information can then be used by a separate filter when processing the inertial data, and is used to bind the INS measurement error growth. The major advantage to a loosely coupled system is its design simplicity relative to a tightly coupled system.

A tightly coupled system integrates both GPS and INS measurements into a single Kalman filter. This has several theoretic advantages over a loosely coupled system. First, any number of GPS measurements may be used by the filter; therefore, even if just one satellite is being tracked, those data can be used within the filter to help bind INS error growth. Additionally, it is possible that both cycle slips may be fixed in GPS data and ambiguity states preserved through periods of GPS signal masking/blockages. The disadvantage to such a system is the complexity of the design and the ability to make such a system functional in practice.

In this method, the virtual gyro signals can be processed separately and can be selected as a single channel, the running average of eight channels, or a twin matrix of opposing 4×4 signals. The wavelet denoising algorithm improves the performance of a selected gyro in each axis or multiple gyros in each axis. The wavelet-based denoising algorithms provide two inputs to a Kalman filter, for example, an unscented Kalman filter (UKF). Alternatively, other types of Kalman filters can be used, including, but not intended to be limited to, a simple, an extended, and a sigma-point Kalman filter. The two outputs include filtered gyro and accelerometer signals for x,y,z and the residue noise on all channels. The noise is monitored and processed by the UKF to update the algorithm. In this way, several different algorithms can be implemented and operated as standalones or in parallel as required by the application. The wavelet denoising algorithm improves the performance of the accelerometer by removing the noise while passing the signal on without the noise content.

The issue of the accuracy of the IMU/INS device of the present invention without the use of a GPS module has also been considered. The design is quite flexible and can be tailored to provide enhanced performance once the design is fully characterized on a rate table. The performance enhancements due to the “virtual” technology, both gyro and accelerometer, can be assessed and the algorithm suite improved to provide a measure of how much further this design can be pushed to meet short-term goals.

The focus of an embodiment of the design is threefold. First, how much additional performance can be realized by switching to the next-generation MEMS gyro device that is scheduled to be available in late 2006, now that the current gyros have been fully characterized with “virtual IMU” technology introduced in this design? Second, can a new accelerometer with much better specifications than the present device provide additional IMU performance? Finally, how much more performance can be realized by utilizing unscented KF algorithms to implement the navigation algorithm suite when GPS-denied has been applied to this unit?

Inertial navigation systems produce all the information that is necessary to completely analyze and explain the motion of an object to which it is attached, for example, a car, a rocket, or a soldier. In the near future many soldiers and vehicles are likely to be equipped with GPS receivers. However, when those GPS receivers are inside buildings, under dense foliage, underground or under water, the GPS signals can be masked. When this happens, the MEMS IMU equipped INS can provide interim navigation until GPS signals are restored and help re-acquire GPS. It is also possible that an enemy will jam the GPS signals. Again, the MEMS IMU-equipped INS can provide location information until GPS service is restored. A key question is how long can a GPS-denied system operate before the accumulated errors inherent in technology overwhelm the ability to predict accurate movements and relative location? Being small and low cost, a MEMS IMU/INS can support the guidance and navigation function in a wide variety of vehicles. Since many of these applications may only need seconds of operation, the errors will remain small. Longer operation times without GPS are needed to support the pointing and orientation for artillery and targeting equipment. Even longer times are needed to help locate soldiers during missions, whether operating in GPS clear zones or in GPS-denied environments.

Since MEMS-based accelerometers and gyroscopes are becoming more attractive to manufacturers of navigation systems because of their small size, low cost, light weight, low power consumption, and ruggedness, how can the inherent error sources be eliminated or reduced sufficiently to sustain operational needs over hours?

Accelerometers and gyroscopes are known as inertial sensors since they exploit the inertial property of bodies. IMUs use accelerometers to measure linear acceleration and gyroscopes to sense angular velocity. A major obstacle IMUs face is its loss of accuracy over time, which is reduced or eliminated by use of more accurate gyros and accelerometers. The operating principles for measuring orientation and position of a moving body using only gyroscopes and accelerometers have been established. High-performance accelerometers with μG resolution and gyroscopes with resolution better than 0.1 deg/h are in demand for inertial navigation systems. Currently, MEMS inertial sensors have grown to the status of commercial exploitation. However, the relatively low performances of these sensors limit their use to less demanding applications. The virtual IMU hardware solution of the present invention, utilizing multiple MEMS sensors to cancel DC errors inherent in MEMS sensor technology and combining the sensor array, realizes significantly improved performance per axis over a single device.

The technology of inertial MEMS sensors has undergone rapid change. MEMS offers several dramatic advantages. The first is what makes the technology possible to begin with: universally accessible fabrication. These tiny parts are manufactured using the same processes as integrated electronic circuits. Because of the manufacturing technology, 10,000 MEMS devices can be built as easily as one. Correspondingly, ease of fabrication allows engineers to change the way they design systems. Economies of scale make production inexpensive. In fact, this massive reduction in cost is the main driver for research. Today, low-cost accelerometers operate in the tactical performance range, while low-cost gyros operate on the outer edge of the tactical performance range.

The processing performed in an embodiment of the present invention significantly improves performance over that of any individual component device by combining multiple gyro devices, which are at present limited to between about 1 and 5 deg/h drift, as mentioned above, by one to two orders of magnitude. The differential ADC devices that are used for each of the gyro inputs are referenced to the reference output of each gyro, and thus all the output data swings±this reference value, and the ADC can be centered over the 12-bit range for each device. In addition, the common mode noise of each gyro is reduced using this differential measurement technique.

The present invention can be used in a wide variety of applications. For example, the assembled device protects the sensors from high-G environments, which can damage the various parts as well as cause measurement errors. In addition, the small, light-weight design renders it an attractive movement detection tool for use by military ground troops. Finally, the substantial improvement in the accuracy of positioning information through the novel combination of multiple, specifically oriented MEMS gyro sensor arrays (hardware gyro), virtual gyros, Kalman filters, and an additional navigational algorithm suggests that the device could find use in guided weapon technology. One of the objectives of the military is to minimize collateral damage in a military confrontation. Accurate information about the location and path of the guided missile should help result in more accurate targeting. The invention is also expected to find use in other IMU applications requiring accurate gyro measurements.

Exemplary system performance values of the inertial measurement unit of the present invention are given in Table 1.

TABLE 1
System Performance Values

| | |
|---|---|
| Dimensions | 2.24 × 1.01 × 0.83 in.³ |
| Volume | ~1.9 in.³ |
| Weight | <0.2 lbs. |
| Power | <2 W |
| Operating temp. range | −40 to +105° C. |
| Output data rate | Programmable 0.01 to 10 kHz |
| Gyro input range | ±300 deg/s |
| Gyro sensitivity | 6 mV/deg/s |
| Gyro noise density | 0.05 deg/s/root Hz |
| Angular random walk | 0.7 deg/root Hz |
| In run stability | 0.7 deg/Hz rms |
| Gyro bandwidth | Settable: typically 40 Hz, max. 3 kHz |
| Accelerometer range | ±4 G |
| Accelerometer sensitivity | 300 mV/G |
| Accelerometer noise density | 170 μG rt Hz (x, y); 350 μG rt Hz (z) |
| Resolution | <2 mG @ 60 Hz |
| Accelerometer bandwidth | Settable: 1 kHz (x, y), 550 Hz (z) |
| Inclination bandwidth | Settable: typ. 10 Hz |
| DSP speed | >500 MHz |
| SDRAM | 32 MB |
| Flash | 3 MB |
| ADC resolution | 12 bits |
| Selectable simultaneous | Programmable, typ. 10 KSPS/ch., max. 1 |
| sample rate (gyro) | MSPS/ch. |
| Selectable sample rate (accel.) | Programmable, typ. 1 KSPS/ch., max. 100 |
| | KSPS/ch |
| Primary digital interface | RS232 or 10/100 Ethernet |
| Secondary digital interface | SPI, UART, JTAG |
| Unused analog interface | 3 12-bit input ch., 4 16-bit output ch. |
| Electrical input voltage | 5.5 or 7-24 V dc |
| Electrical output voltage | 5.5 V |
| GPS module | UART/SPI bus interface |

The combined sensor array IMU of the present invention has four separate modes of operation: calibration, IMU, attitude, and INS. The modes are user selectable from the external Ethernet linked GUI. At power-on, the combined sensor IMU loads the communication protocol with the external GUI. The user selects the desired mode of operation and the software suite download pulls the corresponding user configuration data from non-volatile memory. If no mode is selected, the default value for the initial operation mode is calibration followed by IMU.

The calibration mode represents the most basic operation. In this mode, the combined sensor IMU acquires calibrated values for angular rate, acceleration, and magnetic field. The inclination measurements from the triaxial accelerometer and the angular rate measurements from the gyros are read in, the self-test mode (ST) is initiated, and the errors detected by the ST are measured. The unit adapts, is corrected for all detected errors, and provides the initial values of delta acceleration, delta rate, and delta velocity. The calibration default setting loads default error values.

The IMU mode represents the most basic operating mode. In this mode, the combined sensor IMU uses calibrated values or previously stored values for angular rate, acceleration, and magnetic field. All sensors begin standard operations. The unit adapts to corrected values of angular rate, acceleration, inclination, and North pointing and provides continuous values of delta acceleration, delta rate, and delta velocity.

Attitude mode (AM) adds basic attitude estimation to the IMU mode. In this mode, the data from the rate sensors are accumulated to provide an estimate of attitude. To correct the error drift, the gravity vector (as measured by the accelerometers and corrected by the inclinometer measurements) is used as an indication of whether the V-IMU is level. Additionally, the magnetometer data are used as an indication of North direction. The vertical gyro algorithm heavily relies on the rate sensors so that errors induced from platform acceleration are minimized. A calibration mode under AM, where the unit is first rotated and then its z vector is tilted back and forth are successive modes in which algorithms correct for anomalies, the accelerometer bandwidth is widened, and the full response of the gyros is initiated.

In INS mode, a GPS unit is connected to the combined sensor IMU. This connection can be made over the Ethernet, via a serial bus, or from a second DSP core that replaces the single core DSP device. The communication link and the coupling of the navigation algorithm with the IMU algorithm suite defines how closely coupled the GPS and IMU sensors are joined. The combined sensor IMU provides estimates of position, velocity, and attitude at up to 50 Hz using a state estimation filter. Error-corrected angular rates and accelerations are provided as well. In order to enter INS mode, the combined sensor IMU must be configured for INS operation and GPS must be available and initialized. The combined sensor IMU will not transition into INS mode without a GPS. The combined sensor IMU will remain in extended V-IMU mode until the accuracy of its estimates degrades to an unacceptable level due to lack of GPS measurements.

In order to address some issues that arose during testing of the above-disclosed device, an additional embodiment has been conceived having improved-accuracy algorithms with full motion compensation and sufficient robustness to survive shock levels in excess of 20,000-G forces.

Embodiments employing the functionality 300 include a gyro layout substantially the same as that illustrated in FIG. 6, and having three temperature-compensated arrays of commercial-grade MEMS gyros. These sensors are combined with a near-real-time embedded algorithm suite to achieve improved performance.

Table 2 shows that single commercial-grade devices are specified at 50 deg/h in run stability, whereas the present device measures <0.2 deg/h/axis. These data also indicate how the present improvements compare with both a commercial-grade IMU and an HG1930 IMU. The low scale-factor errors and stability demonstrate the effectiveness of embodiments having the functionality as expressed in the process 300 with an embedded fine alignment solution.

TABLE 2
Component Performance Comparison

| Components and | ADI Commercial | Device of the | |
|---|---|---|---|
| Performance Factors | IDU | Present Invention | HG1930 |
| Gyro | | | |
| Range | ±300 deg/s | ±1125 deg/s | ±1440 deg/s |
| In-run stability | 54 deg/h | 0.2 deg/h | 20 deg/h |
| Gyro fixed bias | | 52 deg/h | 20 deg/h |
| Angular random walk | 4.2 deg/h^{1/2} | 0.383 deg/h^{1/2} | 0.3 deg/h^{1/2} |
| Gyro scale factor error | | 53 ppm | 350 ppm |
| Gyro scale factor | | 81 ppm | 300 ppm |
| stability | | | |
| Accelerometer | | | |
| In-run bias stability | 0.7 mG | 0.04 mG | 0.5 mG |
| Velocity random walk | 2.0 m/s/h^{1/2} | 0.45 m/s/h^{1/2} | 0.15 m/s/h^{1/2} |
| Accelerometer bias | | 0.2 mG | 4 mG |
| IMU Module | | | |
| Self-test | All gyros, | All gyros, 6 | |
| | accelerometers | accelerometers | |
| ADC resolution | 14-bit | 16-bit | |
| Processing | None | Blackfin (500 MHz) | ARM |
| Sensors | Gyros, 1 set of | Gyros, 2 sets of | Gyros, three 30-G |
| | triaxial | triaxial | accelerometers |
| | accelerometers | accelerometers, | |
| | | digital 3D compass | |
| Max. sample rate | 819 SPS | 2000 SPS | 2400 SPS |
| Power | 5 V, 33 mA | 8 V, 225 mA (1.8 W) | 3 W |
| Weight | 16 g | 65 g | 159 g |
| Temperature range | −40-+85° C. | −40-+85° C. | −55-+85° C. |

Two algorithm streams have been embedded in this embodiment of an IMU. One process 300 initializes and continually adjusts the gyro devices individually for optimum performance (FIG. 26). Another process 400 operates on the combined arrays with downstream near-real-time processing (FIG. 28).

Taking advantage of the MEMS gyros (block 301) newly introduced in the art, the individual gyro temperature sensor (block 302) embedded into each gyro device is used to compensate for both temperature changes and null changes of each gyro (block 303). In a particular embodiment, each gyro noise spectral bandwidth is shaped using two passive filters so as to attenuate high-frequency demodulation artifacts by approximately 18 dB. The optimum settings for each device are upgraded once per second. The temperature sensor embedded in each gyro is read, and the readings are averaged. These data are supplied along with the current gyro reading to two quadratic equations, whose coefficients are provided with each device from factor data read in via an EPROM, linked together and operating in the background for each of the gyros. Temperature compensation is achieved over the entire range of −40° C. to >>+85° C. Accuracy is improved by using DC offset removal at two temperature points, recalibrating the gyros to reduce drift. These equations can be extended to both −60° C. and +105° C., if needed, using a simple recalibration procedure when measuring below 1° C. Thus each gyro is processed for optimum temperature and null compensation to create 24 precision gyro devices.

The IMU measures each gyro temperature sensor continuously and corrects each device once per second to achieve maximum overall accuracy. This embedded temperature compensation algorithm improves null stability by over three times (3×), based on the vendor factory reports that individual gyro temperature compensation can achieve better than 75 deg/h null stability with 5 data points over the complete temperature range.

Temperature chamber testing results indicate significant improvements in null stability. An analysis of several data runs recorded over the temperature range from +25 to +70 to −40 and back to +25° C. showed that if the gyro dc offset of each gyro axis were reset at 0° C. and followed a two-piece quadratic algorithm solution that replaces the single quadratic solution implemented at present, the accuracy of the temperature compensation would improve significantly over a wider temperature range. This same compensation technique can be applied to accelerometer arrays. Thus the IMU, accelerometer arrays can be optimized for performance in a similar fashion using factory-supplied temperature coefficient data.

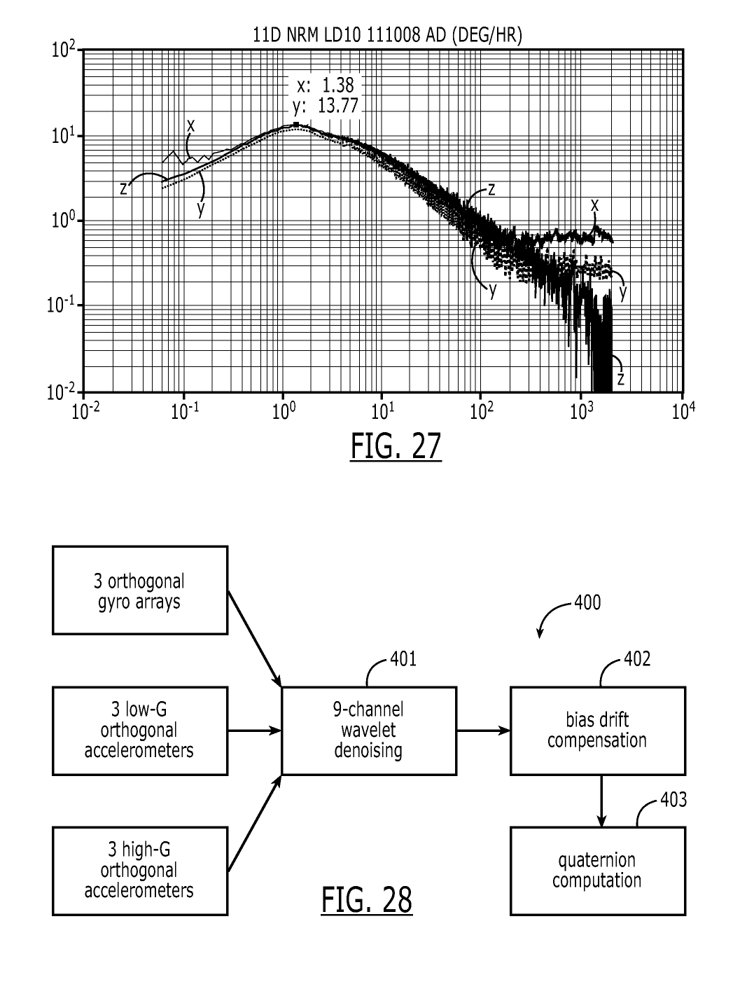

The results shown in FIG. 27 illustrate that when several stages of compensation are combined in order to reduce the noise sources, a goal of <1 deg/h drift can be attained. To achieve this, each gyro is first converted into a precise instrument using null and temperature compensation as discussed above. Next the output of each gyro device is oversampled by increasing the sample rate beyond 2000 samples per second (SPS) for each ADC assigned to each gyro device. Then the gyro output channel data are averaged to a specified sample rate, and the remaining DC offset is removed (block 304).

The integrated algorithm process eliminates the DC offset of each gyro created by the combined gyro and ADC DC offset errors. The DC offset value is measured for each gyro, and that value is saved in EEPROM. Then that value for each gyro is subtracted to zero the DC position of the gyro and the 50/50 swing adjusted by null compensation so that the sensor fusion computation is optimized. In this way, both the individual MEMS gyros and each gyro array have been optimized to operate at maximum precision.

This procedure removes earth rate unless the gyro axis is aligned parallel to the equator. The user can call up a specific mode (“zoom mode”) for detecting earth rate. In this mode, the DC offset computation is eliminated. Then the gyro measurement range is narrowed, which increases the gyro channel sensitivity to measure earth rate, which can be well below the noise floor in the standard mode. The zoom mode then utilizes the wavelet denoising algorithm to recover the slowing changing earth rate in a channel with a lower noise floor than in the standard modes of operation, so earth rate is detectable.

The factory can choose which if any of these processes can be eliminated for a specific application. For example, one algorithm is used to control the 24 gyro ADC sample rate settings for the oversample process. A separate algorithm is used to match the sample rate of the individual gyros before the combining algorithm is initiated for the embedded follow-on algorithm suite operating in near real time. This allows the averaging of subsequent gyro readings at high oversampled rates (block 305; programmable setting: 2-8 KSPS) and supply the follow-on processing sampling at lower rates (e.g., 500 or 125 SPS) to take advantage of gyro noise averaging and to reduce the delays inherent in the high-sample-rate real-time wavelet denoising algorithm.

To perform IMU optimization after fabrication and encapsulation, the procedure for the substitution of one gyro for another in each orthogonal sub-array achieves further performance optimization. This procedure eliminates noisy gyro devices as well as optimizing the performance of each channel in terms of gyro drift and angle errors. To summarize, in terms of Allan deviation improvements as but one measure of comparison, the best single gyro curve measures >50 deg/h drift. The results of the Allan deviation curve after temperature/null/oversampling/offset and averaging followed by wavelet denoising measures between 7.2 and 10 deg/h drift stability, as shown in FIG. 27. This represents a seven-fold (7×) improvement factor.

Improvements have also been made to the near-real-time algorithm suite 400 for the arrays, the flow for which is illustrated in FIG. 28, and the orthogonal orientation of which is illustrated in FIG. 30. When surface micro machined sensors are treated, not as individual instruments, but as arrays, the positioning of the devices in the module as well as the fusion and filtering mathematics, reduce the inherent silicon noise sources. Although exemplary chips from Analog Devices, Inc., have been used, the technique can be applied to any single- or multiple-axis device. In this exemplary embodiment 350, a total of three groups 351-353 (one for each of the x, y, and z axes) of eight gyros 355 each are used, totaling 24 gyros. One low-G accelerometer 354 is visible in this view.

The outputs comprise digital voltage signals from the combined gyro signals and the two sets of accelerometers, all with signal conditioning performed internally in an DSP. The individual gyro sensor analog outputs are sampled by 16-bit analog-to-digital (ADC) devices at a 2-kHz sampling rate, and the accelerometer outputs are sampled by 16-bit ADCs at 0.25-kHz sampling rates. All the gyro data channels are synchronized and sampled simultaneously to simplify the algorithm processing.

The wavelet denoising algorithm (block 401) operates in near real time to greatly reduce higher-frequency random noise and reveals lower-frequency bias fluctuation, particularly for the gyros. This is addressed by the application of real-time gyro bias drift compensation (block 402) using simple linear Kalman filters, one for each gyro axis, referenced by the accelerometers' sensing of angle relative to the gravity vector. This has been demonstrated to be effective for gyro drift compensation when the IMU is stationary. For proper implementation of the gyro drift compensation, it is important to achieve accurate factory calibration and alignment of the gyros and accelerometers. The delays for the wavelet denoising computations have been reduced significantly in the present device 350. The three additional embedded algorithms, the fine alignment settings and computations, the gyro combining array computations, and the gyro bias drift compensation (block 402) computations all operate in real time.

Details of the gyro drift compensation architecture 402 are illustrated in FIG.

To apply the bias-drift-compensated technique to general motion, it was first necessary to achieve calibration and fine alignment of the accelerometers and gyros. The components were positioned in the potted assembly. The three-axis accelerometers of this embodiment are contained within a single integrated circuit package, and the axes are specified to be mutually orthogonal to within 0.1 deg. The accelerometer frame, however, was found to be slightly skewed relative to the IMU external surfaces, which are not precisely parallel and orthogonal. Also the response from each axis is subject to a small, unknown, zero-gravity bias error.

To correct for the zero-gravity bias, it was necessary to separate the constant-gravity response from the unknown bias in order to accurately correct by measuring and subtracting the unknown bias. A procedure was devised in which static measurements are first taken in six different positions referenced by the IMU external surfaces, each pair of surfaces nearly aligned orthogonal to the gravity axis for two positions. A set of six independent quasi-linear equations relating the unknown biases can be formed and differenced in pairs to produce three linear equations from which the unknown offsets were determined.

After correction and rescaling by the Euclidean norm of the three-axis gravity response, the Euler angles required to rotate the accelerometer frame to align with the gravity axis were determined. Removal of the unknown zero-gravity bias is necessary also to track the orientation of the accelerometer frame during dynamic motion. It has been determined that the rms error in alignment is less than 2 mrad over a 5-sec interval. This is sufficient to accurately track rotation relative to the gravity axis for the purpose of referencing the gyro bias compensation and quaternion bias compensation filters, to be described in the following.

The gyros must also be aligned with the accelerometer frame. Unlike the accelerometers, the gyros consist of three separate packages, each comprising a group of eight integrated circuits assembled to define a single rotation axis. Within the IMU each gyro group rotation axis is skewed with respect to its corresponding accelerometer axis. The purpose of the alignment is to find the rotation transformation that aligns the axes with respect to their orientation and to measure the signs of rotation. The process can be separated into coarse and fine alignment. Coarse alignment associates the gyro axes with their corresponding accelerometer axes and determines the sign of rotation for each. This is facilitated by rate table measurements, each positioning an orthogonal IMU surface normal to the vertical gravity vector. While the axis association can be determined from the physical orientation of the gyro groups in the folded package, that axis association can be verified by forming the cross-products between the three-axis gyro and accelerometer response vectors subject to rotational motion around the gravity axis. After the correct permutation of gyro response vectors was confirmed, the sign of rotation of each gyro axis was found by forming the scalar products of the gyro and accelerometer response vectors with knowledge of the direction of rate table rotation. The coarse gyro alignment results, which have been determined, are applicable to all IMU units having the same construction.

Fine alignment requires similar rate table measurements with careful positioning of the IMU so that the gyro axis for each position is coaxial with the rate table's vertical rotation axis. A special positioning fixture was fabricated for this, after which the rate table measurements were performed. From these data on the fine alignment of the gyros, the dynamic gyro bias-compensation process was implemented and tested. Fine alignment of the gyros requires separate measurements and alignment computations for each different unit during factor calibration.

The wavelet denoising embedded algorithm (block 401) has been modified to operate at near-real-time operation in response to issues experienced during testing. When the size of the wavelet denoising data packets was reduced by fourfold (4×), it was thought that performance sensitivity would be impacted. This was not the case. The preproduction units still meet both the ±1125 deg/sec range, as well as the 2 mil angle drift, and are less than 0.5 deg/h in run gyro drift performance levels when measured for less than 30 min. The units with ±250 deg/sec angular rate range and narrower bandwidth still achieve Allan deviation levels of less than 0.1 deg/h gyro drift. As a result of these changes, the near-real-time operation was improved from 17% to 50% on time responsiveness.

The use of wavelet denoising for both the accelerometers and the combined gyros of each axial group greatly reduces the higher-frequency random noise and reveals the lower-frequency bias fluctuation, particularly for the gyros. This presents an opportunity for real-time bias drift compensation using simple linear Kalman filters, one for each gyro axis, referenced by the accelerometers' sensing of angle relative to the gravity vector. This has been demonstrated to be effective for gyro drift compensation when the IMU is stationary.

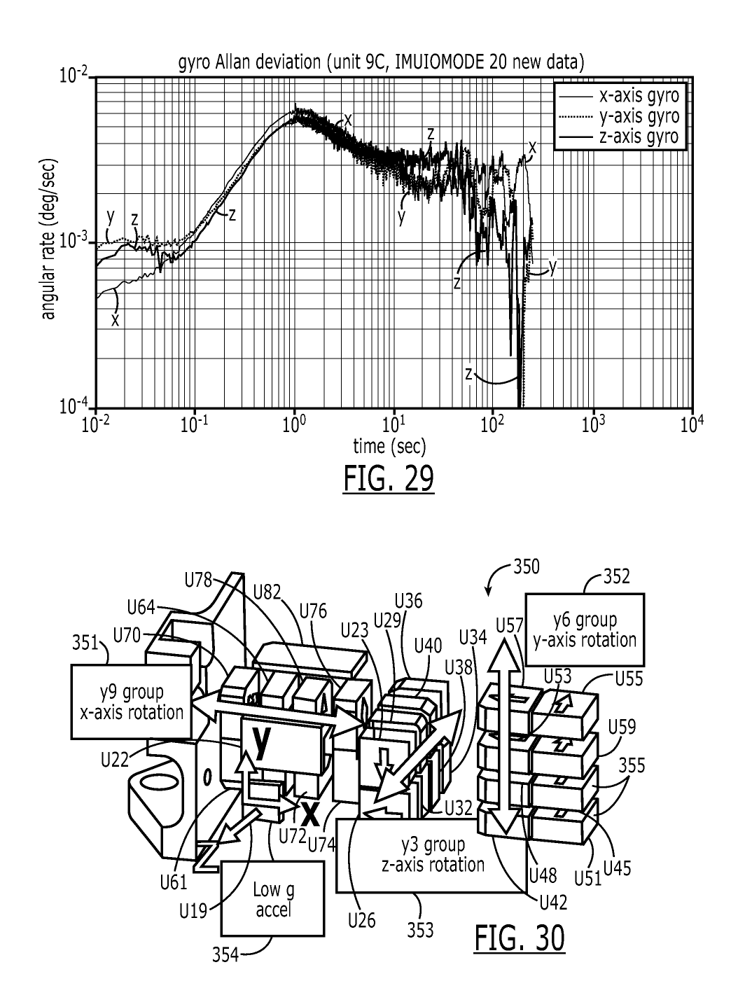

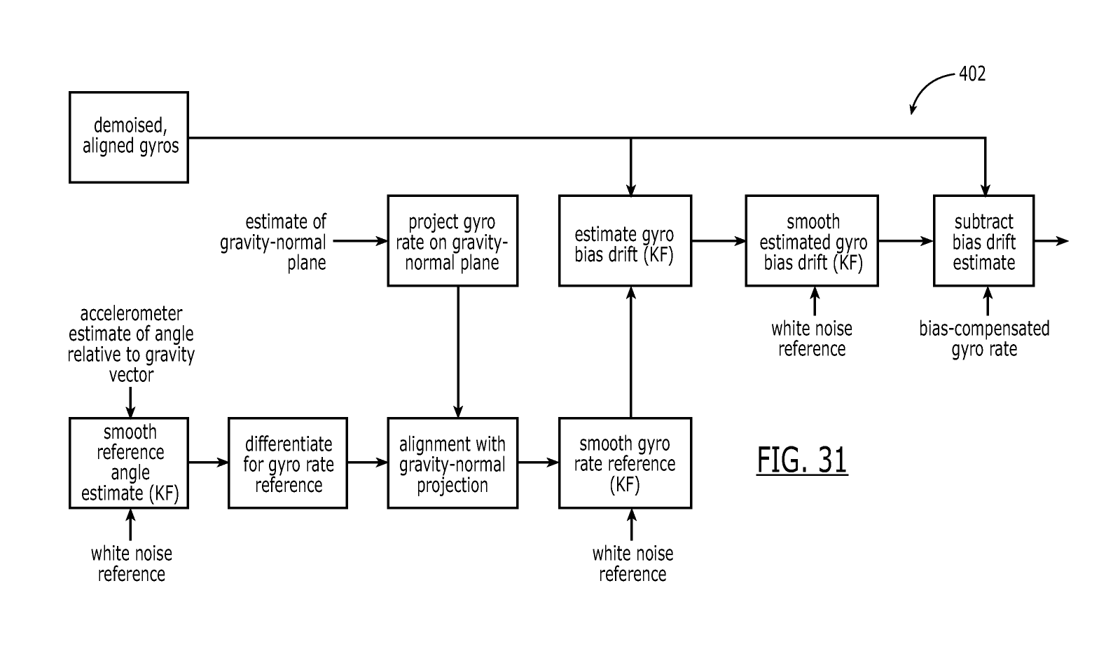

FIG. 29 shows the Allan deviation curve for all 3 gyro axes of an exemplary unit. This vastly improved performance is attributable to the new gyro bias compensation algorithm (block 402) processing that follows directly after the wavelet denoising operations (block 401) for all three gyro channels. In comparison with commercial gyro drift performance (Table 2, In-run stability), this unit demonstrates a factor of greater than seventy seven-fold (>77×) improvement for the least sensitive axis and over five hundred times (500×) for the best-case z axis. Other IMU units have shown even better gyro drift performance; hence, there will be a future focus on unit-to-unit and axis-to-axis consistency.

A procedure for accurate alignment and scale factor correction has been developed, tested, and implemented. The computations for each IMU are derived from the 6-position data recorded on the rate table. This exemplary unit contains the alpha version of this algorithm solution. The resulting information is recorded in the EEPROM for each IMU. The data are used by the embedded computations to perform alignment and scale factor corrections for the 3 gyro channels and the low-G triaxial accelerometer. This procedure will be expanded to include the alignment and scale factor correction of the high-G accelerometers as well. In future, the alignment algorithm operations will be expanded for the IMU packaged in the enclosure to eliminate misalignment errors.

To address the issue of earth rate detection, a new “zoom in” mode has been incorporated into the control software to allow the user to select a mode whereby each gyro sub-array sensitivity is enhanced to detect signals at much lower noise levels by taking advantage of controls for angular rate range, 16-bit ADC range, and wavelet denoising threshold levels. The user can eliminate the routine that corrects for DC offset in this mode to assist in the acquisition of earth rate and the determination of north-pointing reference.

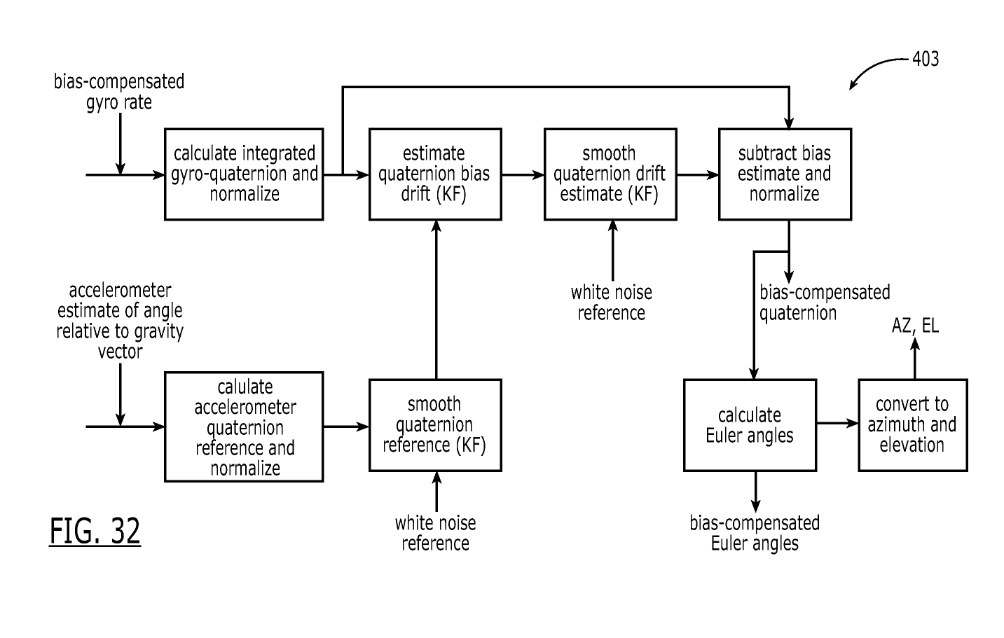

Another embodiment of this algorithm includes the implementation and test of a real-time wavelet filter as well as the implementation of quaternion computations (block 403) to create a mode to display INS outputs. Details of the residual gyro-bias compensation applied to the quaternion angle representation are provided in FIG. 32. Since some applications cannot tolerate any delay, a denoising filter similar to that used in embedded processing for medical instrumentation will be tested and comparisons with the present implementation will be made.

Several CGCS deficiencies noted in testing have been identified and are being addressed. Near-real-time performance is not acceptable for medium- and high-speed scenarios, especially those for projectile applications. At present, the unit has a small time delay before data are recorded to a laptop at the 460-kb rate. Additionally, the gyro drift compensation algorithm does not operate over the full angular range of ±1125 deg/sec. An angular range of ±200 deg/sec has been measured. This was due to a computational overflow error detected in the fixed-point mathematics, which is being corrected. A “dead zone” was also measured near zero angular rate. This is the range where the static gyro compensation algorithm is switched off if significant rotation is detected on an axis (individually). Additional algorithm development will be undertaken to replace the switch with a full motion compensation algorithm.

Although the triaxial accelerometer is reported to have improved performance and better shock survivability without DC offset damage, arrays of these accelerometers may be required to achieve the upgraded performance needed to specific requirements.

The data for a shock surviving IMU as well as all 32 individual sensor channels were recorded and analyzed. Direct comparisons of each sensor device both before and after exposure to high-G shocks showed that the shock did change the DC offset setting of several gyros and the low-G accelerometer device. The DC offset for each orthogonal gyro axis showed significant change for one axis but little or no change for the other two axes. The Allan deviation measurements were directly impacted, however. MEMS gyros as well as the combined array of precision gyros are quite sensitive to DC offset. One device in the array with offset can degrade array performance. Measurements showed that two of the axes defaulted to pre-gyro compensation ranging from 14.5 to 11 deg/h and 1-1.2 deg/h for in-run drift because of the changes to DC offset. These data measurements identified in the post-shock testing identifies the need to add a dynamic compensation element to the present precision instrument algorithms of FIG. 26 in order to reduce the impact on DC offset caused by high-shock encounters.

In order to operate under motion conditions, the alpha version of embedded gyro drift compensation has a mode switch function. At present, angular motion can be detected independently in each axis. When significant angular rate is detected, the bias compensation computation is bypassed. When the motion is reduced sufficiently, bias compensation is restored. This creates a “dead zone,” as measured. For large values of DC offset, the switch will not reset and the bias compensation will be removed.

MEMS device factory discussions were conducted to address the DC offset error observations after shock exposure. An improved triaxial device, the ADXL335, is now available that will provide much improved operation at high g shock levels. An improved gyro is also being sampled that will have improved noise floor performance as well as improved high g shock performance. Note that the high-G accelerometers did not demonstrate much change in DC offset levels after shock exposure.

FIG. 29 depicts the efficacy of the high-G miniature IMU, plotting the gyro Allan deviation for the x, y, and z axes.

Laboratory tests are underway to evaluate both an improved production triaxial accelerometer as well as an array of these triaxial accelerometers to replace the present preproduction device. The IMU layout will be modified to accept either solution in the next fabrication cycle. The next fabrication cycle will also utilize the improved version of the gyro device now in use to reduce the noise floor by two times (2×). Both devices will provide improved performance.

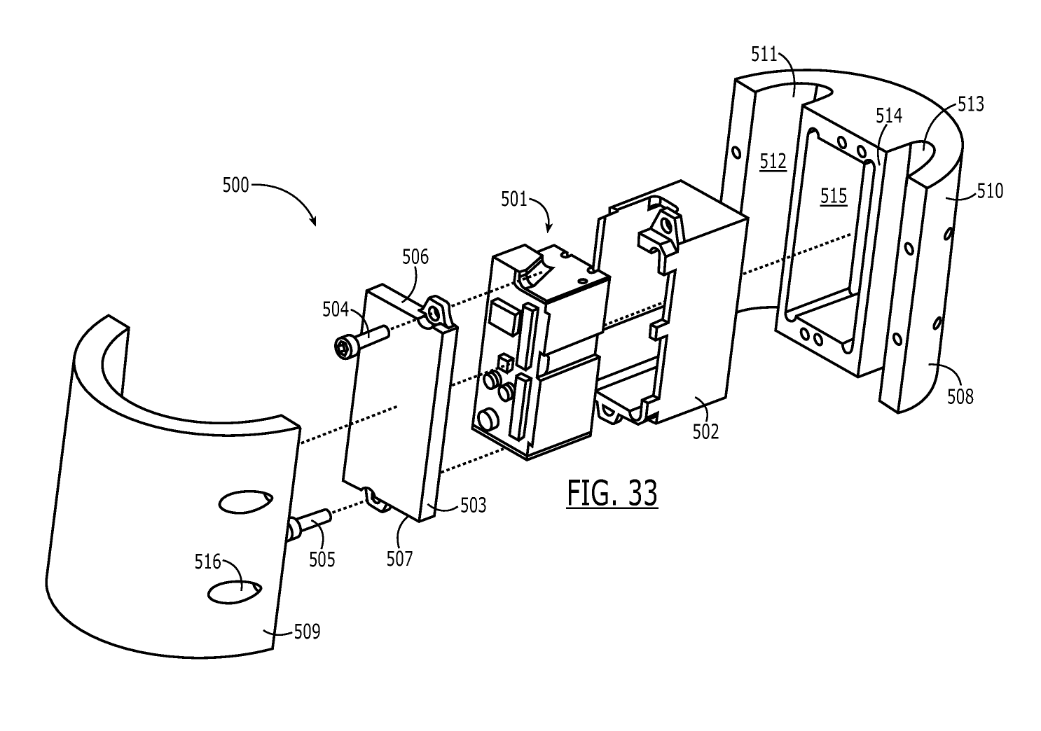

An IMU 500 is also provided having improved exemplary package enclosure (FIG. 33), or housing, also provides additional ruggedness and IMU alignment assistance. This embodiment 500 includes an exoskeletal arrangement wherein the electronic element package 501 is positioned inside a substantially box-like primary housing having a primary casing portion 502 and a primary lid 503 affixable thereto using, for example, a pair of screws 504,505 along a top 506 and bottom 507 thereof. The primary housing 502,503 is then positioned within a substantially cylindrical secondary exoskeletal housing, which comprises a secondary casing portion 508 and a secondary lid 509 affixable thereto. The secondary casing portion 508 has a semi-cylindrical outer wall 510. An interior wall 511 describes a portion of a cylinder on opposed sides 512,513 thereof. Between the opposed sides 512,513 is a substantially box-like support 514 for holding the primary housing 502,503 within an interior space 515. The secondary lid 509 comprises a semi-cylindrical element matable with the secondary casing portion 508 using, for example, countersunk screw holes 516, although this is not intended as a limitation. When joined, the secondary casing portion 508 and secondary lid 509 substantially describe a cylindrical element.

Algorithm upgrades are underway to address the need for real-time performance and 100% motion compensation.

The IMU of the present invention uses off-the-shelf sensor technology to achieve better than tactical-grade performance. That is, from commercial-grade devices, the performance enhancement is more than two orders of improvement in drift and accuracy. The individual MEMS devices' performance levels are purposely limited so that these devices can be sold worldwide.

This performance level has been achieved with the use of an advanced suite of algorithms that have optimized individual gyro performance, optimized gyro array performance, and combined wavelet denoising and static bias compensation to achieve a stable and accurate IMU.

By way of example with regard to structure and packaging, a simplified hardware solution leverages a proven ability to attach three identical semi-rigid flex components to a master semi-rigid flex board wrapped around the smaller components to make up the complete assembly. The core, consisting of the three identical semi-rigid flex components, is folded and potted into cubes. Each cube contains the array of MEMS gyros, a high G accelerometer, and dual ADC devices to convert gyro data simultaneously at two different levels of resolution. The cubes are positioned such that both the gyros and the high G accelerometers are orthogonally positioned on three axes. Each cube is pre-tested to verify functionality and expected performance levels. Each cube records the sensors' changes to temperature enabling algorithms operating in the background to compensate for temperature changes. The trio of cubes is set for a maximum oversampling rate, then an optimum average rate is established for each suite of gyros to control the IMU's gyro output sample rate. The digital output bus may be identical for each cube. The main processor wrap-around board contains a three-dimensional accelerometer array that is synchronously slaved to the IMU's gyro sample rates.

The main processor board contains two DSP devices. The first DSP processes all 100 sensors simultaneously at high sample rates. A second embedded processor houses a suite of INS algorithms. The under-utilized processor architecture is available to contain guidance and control algorithms together with the I/O for actuator controls, and/or a real time video-frequency processing link to enable the system to operate together with other system components in the same case. A GPS receiver module embedded on the board can be used or its bus can be bypassed for external GPS inputs.

By way of example, one improved gyro cube includes a two sided board with only 4 panels encased in a thin plastic sheath to fill and hold the potting material. The cube is small enough such that the stacking of three cubes desirably fits precisely on the back of the processor wrap board to be lap soldered with alignment holes both on the tabs of each cube and on the back of the processor board to align with the connection pads. The gyros are placed together on each panel, each twisted 90 degrees around the other and when they are folded, they represent a mirror image. That was the original patent description and that has been duplicated here. The processor board contains dual DSPs that divide up the computations into either a parallel or serial architecture. External inputs take in GPS data to process with a navigation algorithm suite. Alternatively, an internal GPS module provides GPS data for comparison with GPS denied operation, the primary mode of operation. Additional sensors are present including the barometer and mag sensor. The second processor performs the navigation algorithm suite. The Sigma Point Kalman Solution continues to sustain the low drift error results provided by the first DSP algorithm suite. The hour+ of low drift errors is extended to many hours under this arrangement.

The wireless access point is SPI bus connected to the DSP for high speed interconnection operation. Not only can the data flow out, but specified controls can reset or recalibrate the unit on the fly based on user inputs, dynamic platform motion considerations and environmental conditions. A tested synch pulse output provides an external reference output sample rate to all external equipment. The SPI based sensor IO bus connects each sensor array to the processor. High speed computations of each sensor align each subarray of sensors precisely within a 10 ns window to permit each subarray to perform as a single precise sensor. Additional processing functions reduces the noise floor and compensates for temperature changes in each sensor.

Both types of arrays of inertial sensors are pre-selected and placed on the circuit board in pairs by the teachings of the present invention including a process that reduces sensor drift errors dramatically over the use of a random selection criteria of sensor placement.

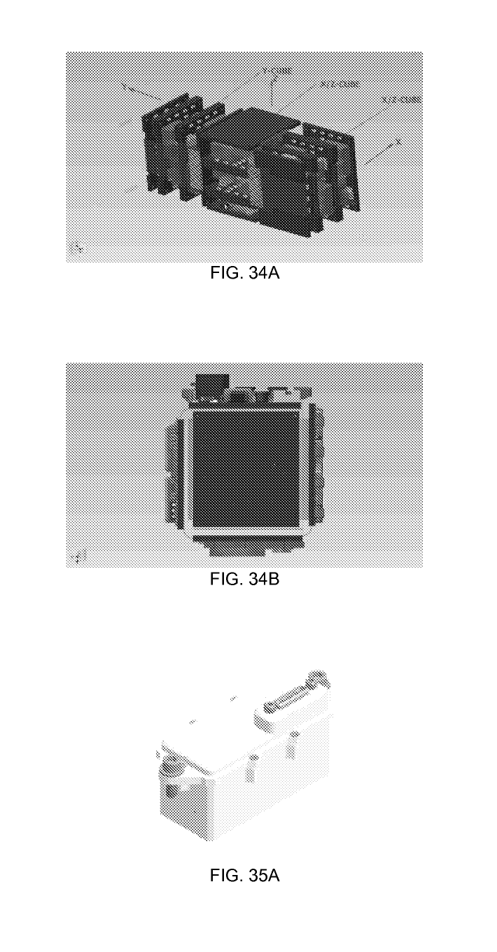

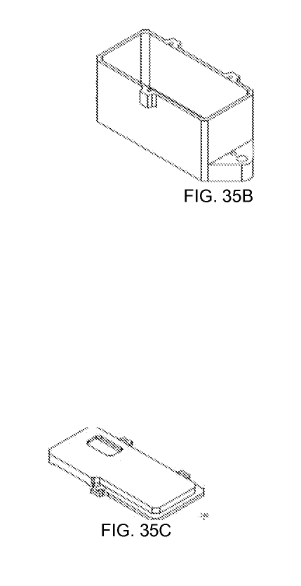

As illustrated with reference to FIGS. 34A and 34B, one embodiment of an IMU/INS to be carried in an exoskeleton case illustrated with reference to FIGS. 35A-35C contains over 100 sensor data channels processed for real-time operation. The IMU/INS is contained in a volume of 3 cubic inches, weighs 0.3 pounds, and consumes 2.4 watts of power. Its environmentally rugged design also accommodates both an optional GPS receiver and a barometer embedded in the processor board. The exoskeleton case can be fabricated either from metal or high-impact plastic. The I/O and power connector can be either exposed for easy access or recessed and sealed for ruggedization.

The exoskeleton case contains the electronic module, the folded up circuit electronics, that is potted into the case. The choice of potting materials and case materials optimizes the heat transfer so that the unit remains at a constant temperature although elevated temperatures are controlled by a temp compensation algorithm. This choice of materials also determines the maximum level of shock and vibration that the unit can tolerate during both high shock environments and sustained vibration environments, the two most dominant environments to be considered.

The IMU utilizes arrays of MEMS vibration-resistant inertial devices orthogonally positioned to provide 3D coverage. The sensor arrays are systematically combined in subarrays optimally weighted to minimize Angle Rate Walk, Bias Instability, and importantly, Random Rate Walk found to be the dominant source of long term angle drift.

The same drift-reduction processing is also applied to the 3D accelerometer array. Upgraded real-time embedded operational code implements a mathematical morphology-based sensor denoising algorithm that is applied separately to both the gyro and the accelerometer arrays to optimize the transient response of each set of inertial sensors. This innovation replaces a wavelet-based denoising filter that contained transient artifacts from transformation between the time and frequency domains, and it significantly reduces throughput delay (latency).

Electronic calibration and alignment of the IMU is applied at the individual sensor level. The calibration and alignment parameters are determined offline from specified measurements, then latched into the embedded software. Sensor calibration compensates for coupled bias-offset and scale-factor errors, equalizing the sensors in each type of array. Orthogonalization adjustment of Cartesian axes is applied as needed. The 3D accelerometer array is precisely aligned with the exoskeleton case and the gyro-array cubes are then aligned with the accelerometers.

The low-drift performance of the IMU/INS is optimal by combining the sensors in combinatorially-selected subarrays. For the gyros, this is enhanced by Kalman-filter compensation referenced by the accelerometers' measurement of tilt relative to the gravitational vector.

The low-drift array optimization technique has been applied to the separate gyro and accelerometer axes with equal success. From experiments and analysis, it has been observed that resulting system will be capable, not only of accurate azimuth sensing, but also accurate earth rate detection for nonmagnetic geodetic north finding to enable gyrocompassing in GPS-denied environments. Improved algorithms expand the instruments to a fully enabled north-finding product to be packaged with the navigation system, or the IMU's functions can be separated to create a suite of products for different user needs. The low-drift IMU can provide all these capabilities with a full processing/connectivity hub for USB add-ons.

The structural design permits embodiments to interface with a host of sensors and systems. By way of example, a full processing/connectivity hub for both military and industrial systems may be processed. Unused parallel ports may process real-time video or interface to a variety of high speed digital converters to process radar data; medium speed serial ports with SDLC-like protocols may operate over RS422, and 2.0 USB as an option.

Teachings of the present invention include achieving accuracy by using arrays of sensors and to combine them in complementary pairs to reduce common mode noise and drift that induces errors in the time-integrated outputs. This principle is applied in several layers culminating in the optimum-weighted combination of paired subarrays.

By way of example, first consider only the gyros, but the same observations apply to the accelerometers as results have demonstrated. Earlier, the impact on reduced error was achieved by moving from single gyros to an array of eight. The 8-element array, even if sensors were combined in the same orientation, reduces ARW, the higher frequency white noise in the gyro rate that gives rise to a component of angle random walk. Bias instability, the short-term variance in the slowly fluctuating mean of gyro rate, is also reduced. By orienting the sensors to suppress common mode effects, bias instability and ARW are reduced to a greater extent. Rate walk, the random walk in sensor bias, is also reduced. The improvement is readily seen in root-Allan variance which makes an ensemble-average estimate of variance followed by taking its square root. The remaining array optimization is aimed largely at reducing random rate walk (RRW), the component of gyro rate that is fluctuating very slowly. Rate walk dominates the error over long duration, magnified when integrated to angle, so the object is to drive it toward zero. The same considerations apply to the accelerometers where position errors are further magnified from double integration over time.

By way of example, when subarrays of gyros (and accelerometers) are selected in pairs from the available 8 on each axis, the impact on Allan deviation is to flatten the curve in the rate walk region beyond the bias stability region. When subarrays of gyros, or accelerometers, are selected in pairs for low drift and those pairs combined optimally to further reduce drift, the impact on reducing RRW and sensor drift is even greater.

Presently, ongoing MEMS gyro development continues to seek yet further improved low noise and low-drift through the development of rate-integrating gyros to achieve accurate angle estimation. Embodiments of the present invention apply to both MEMs gyros and accelerometers, achieve substantial performance benefits using MEMS sensor arrays and optimal array combining algorithms to minimize noise and drift. As above described, a method aspect of the invention comprises, selecting and combining arrays of gyros and accelerometers in such manner as to achieve low noise and low drift.

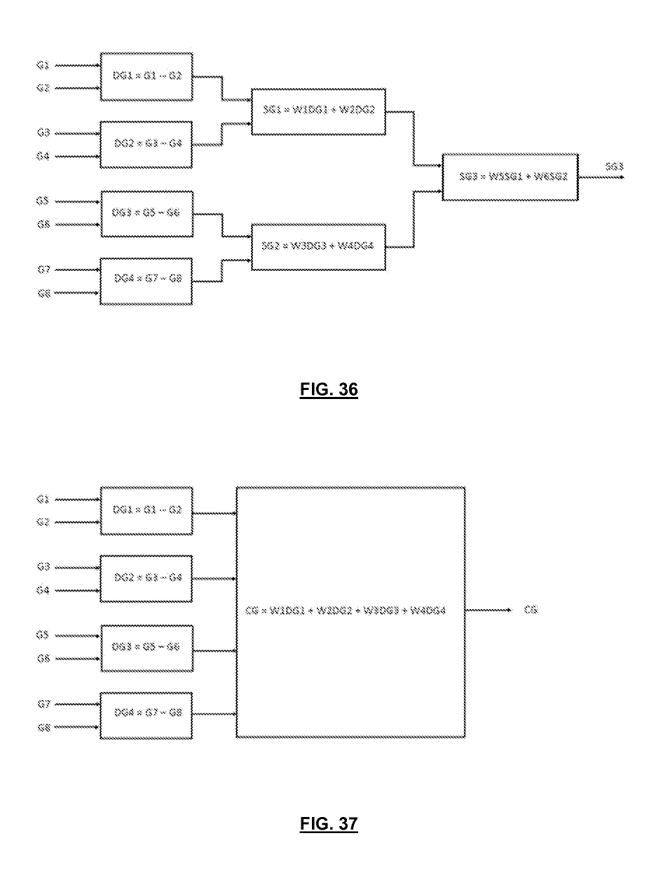

Method embodiments of the invention, herein described by way of example, include preselecting gyros for an IMU assignment in pairs; combining gyros based on pairs for low-drift; determining weight for gyros to be combined in tiered pairs; and a process for combining gyros for gyro low-drift. As herein described, tiered make reference to the functional steps described by way of example in FIGS. 36-39, as in tiers or layers in a process flow.

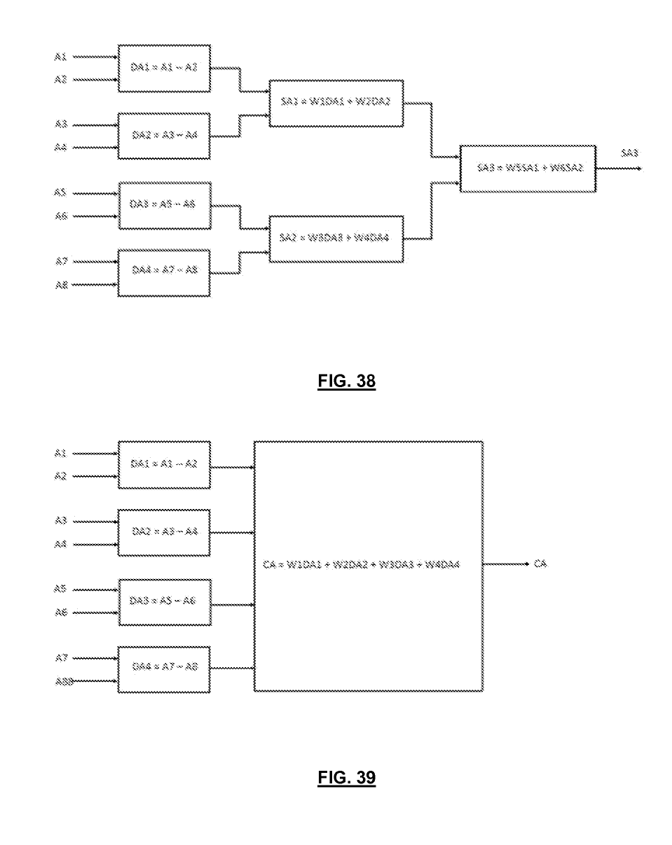

With continued reference to FIGS. 36-39 illustrating one method according to the teachings of the present invention is directed to selecting gyros and accelerometers operable in an inertial measurement unit and navigation system to achieve low-drift measurement accuracy for operation in a GPS-denied environment, the method comprises (a) preselecting pairs of gyros for IMU physical assignment to achieve low-drift measurement accuracy; (b) determining optimal weights for gyros to be combined in tiered pairs exhibiting low drift; (c) combining assigned gyro pairs based on quadratic optimization to achieve low-drift; or (d) determining weights for accelerometer optimal low-drift pair combining in tiers; and (e) combining assigned accelerometer pairs in aggregate for low drift using pair weight selection by minimization of a quadratic form, wherein FIG. 36 is a functional block diagram illustrating one process according to the teachings of the present invention for combining low-drift gyro pairs in successive tiers; FIG. 37 is a functional block diagram illustrating a process according to the teachings of the present invention for combining low-drift gyro pairs in aggregate; FIG. 38 is a functional block diagram illustrating one process according to the teachings of the present invention for combining low-drift accelerometer pairs in successive tiers; and FIG. 39 is a functional block diagram illustrating one process according to the teachings of the present invention for combining low-drift accelerometer pairs in aggregate.

With regard to FIGS. 36-39, G1, G2, G3, G4, G5, G6, G7, G8 represent are individual gyro outputs; DG1, DG2, DG3, DG4, represent differenced gyro outputs as shown; W1, W2, W3, W4, W5, W6 represent combining weights; SG1, SG2, SG3 are sums of weighted gyro differences as shown; CG represents a sum of weighted gyros differences as shown; A1, A2, A3, A4, A5, A6, A7, A8 represent individual accelerometer outputs; DA1, DA2, DA3, DA44, represent differenced accelerometer outputs as shown; SA1, SA2, SA3 represent sums of weighted accelerometer differences as shown; and CA represents a sum of weighted accelerometer differences as shown.

By way of example, preselecting gyros for an IMU assignment in pairs comprises the following steps:

a) from a batch of B_{g} gyros pre-select N_{g}<B_{g} gyros to assign to designated positions on each axis of the IMU hardware;

b) examine all combinations of B_{g} gyros selected in differenced pairs, comparing long-duration drift of each different pair in angle-rate, and in angle-rate integrated to angle, using a suitable metric for comparison;

c) select Ng gyros comprising the lowest-drift combination of N_{g}/2 pairs in which any individual gyro in the batch of B_{g} gyros is used only once;

d) in accordance with positive and negative signs of differenced gyros in the set N_{g}, assign those gyros to designated positions on one axis of the IMU hardware;

e) select gyros for assignment to the other axes of the IMU: and

f) repeat the above process, starting with a new batch of B_{g} gyros, or the remaining gyros from an earlier set that have been reduced by a prior selection.

A gyro low-drift process based on combining selected gyro pairs in successive tiers for low drift comprises the following steps: a) start with a plurality of N_{g} gyros for each axis, assigned to IMU hardware in N_{g}/2 pairs pre-selected for initial low drift; and

b) create a summed combination of N_{g}/2 gyro pairs on each axis with binary combining weights on successive tiers chosen to minimize drift in the output of the combined full set of gyro pairs.

A weight determination for low-drift gyro pair-combining not necessarily in tiered pairs, comprises the steps of a) given a plurality of N_{g} gyros for each axis, assigned to IMU hardware with a summed combination of N_{g}/2 gyro pairs on each axis, determine combining weights by minimizing a quadratic form.

A process to preselect individual accelerometers for IMU assignment in low-drift pairs, wherein the sensors are not physically constrained, comprises:

a) from a batch of Bₐ accelerometers, pre-select Nₐ<Bₐ accelerometers to assign to designated positions on each axis of the IMU hardware without prior physical sensor constraints as follows:

b) examine all combinations of Nₐ accelerometers selected in differenced pairs comparing long-duration drift of each different pair using a suitable metric for comparison;

c) select Nₐ accelerometers having the lowest-drift combination of Nₐ/2 pairs in which any individual accelerometer in the batch of Bₐ accelerometers is used only once;

d) in accordance with positive and negative signs of the differenced accelerometers in the set Nₐ, assign those accelerometers to designated positions on one axis of the IMU hardware; and

e) to select accelerometers for assignment to the other axes of the IMU, repeat the process described, starting with a new batch of Bₐ accelerometers, or the remaining accelerometers from an earlier batch that has been reduced by a prior selection.

A process to preselect individual accelerometers for IMU assignment in pairs, wherein the sensors are tri-axially constrained, comprises:

a) from a batch of Bₐ accelerometers, pre-select Nₐ<Bₐ accelerometers to assign to designated positions on one axis of the IMU hardware without physical sensor constraints;

b) examine all combinations of Nₐ accelerometers selected in differenced pairs, comparing long-duration drift of each different pair using a suitable metric for comparison;

c) select Nₐ accelerometers of the lowest-drift combination of Nₐ/2 pairs in which any individual accelerometer in the batch of Bₐ accelerometers is used only once;

d) in accordance with positive and negative signs of the differenced accelerometers in the set Nₐ, assign those accelerometers to designated positions on one axis of the IMU hardware; and

e) for the other axes the sensor placement is constrained physically by the tri-axial configuration and the prior sensor assignment on the preferred axis.

A process for accelerometer low-drift pair combining weight determination in successive binary tiers, wherein the sensors are not physically constrained, the process comprises:

a) given a plurality of Nₐ accelerometers for each axis, assigned to IMU hardware in Nₐ/2 pairs pre-selected for initial low drift; and

b) create a summed combination of Nₐ/2 gyro pairs on each axis with combining weights chosen in successive binary tiers to minimize drift in the output of the combined accelerometer pairs by minimizing a quadratic form.

A process for accelerometer low-drift pair combining weight determination in successive binary tiers, wherein the sensors are tri-axially constrained physically, comprises:

a) given a plurality of Nₐ triaxial accelerometers for a preferred axis, assigned to IMU hardware in Nₐ/2 pairs pre-selected for initial low drift;

b) remaining axes utilize the accelerometers assigned accordingly;

c) summed combination of Nₐ/2 accelerometer pairs on the preferred axis with combining weights chosen to minimize drift in the output of the combined pairs from minimization of a quadratic form; and

d) for the acceleration sensors on remaining axes, determining the binary combining weights for the assigned sets of pairs uses the same constrained minimization algorithm.

A process for accelerometer low-drift combining, not necessarily in successive tiers, using constrained optimization, wherein the sensors are either not physically constrained or tri-axially constrained, comprise:

a) given a plurality of Nₐ accelerometers for each axis, assigned to IMU hardware with a summed combination of Nₐ/2 accelerometer pairs on each axis;

b) optimal weights for combining the Nₐ/2 accelerometer pairs on each axis are determined to minimize drift in the output of the combined accelerometer pairs by minimizing a quadratic form; and

c) determination of the optimal combining weights is based on constrained optimization using standard and well-known mathematical algorithms.

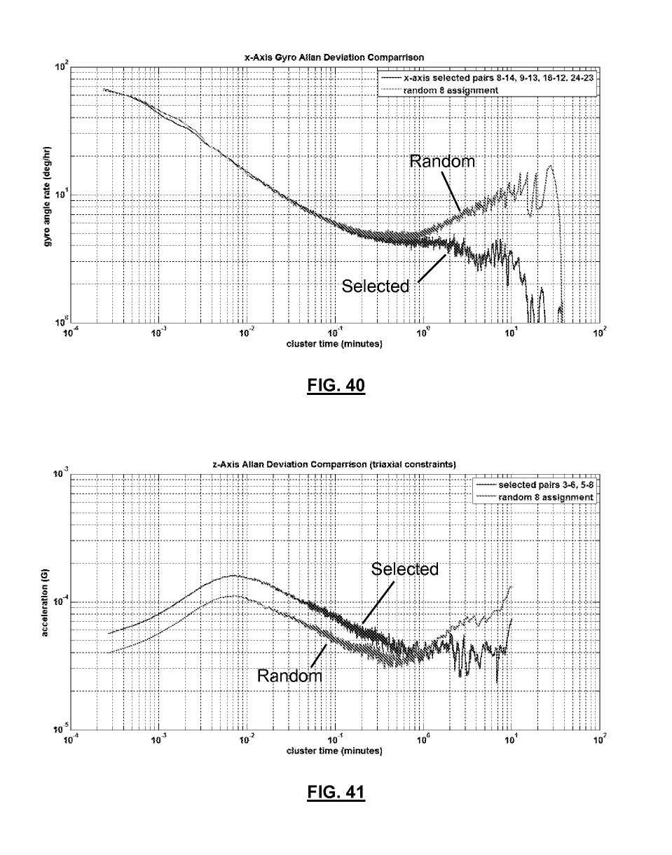

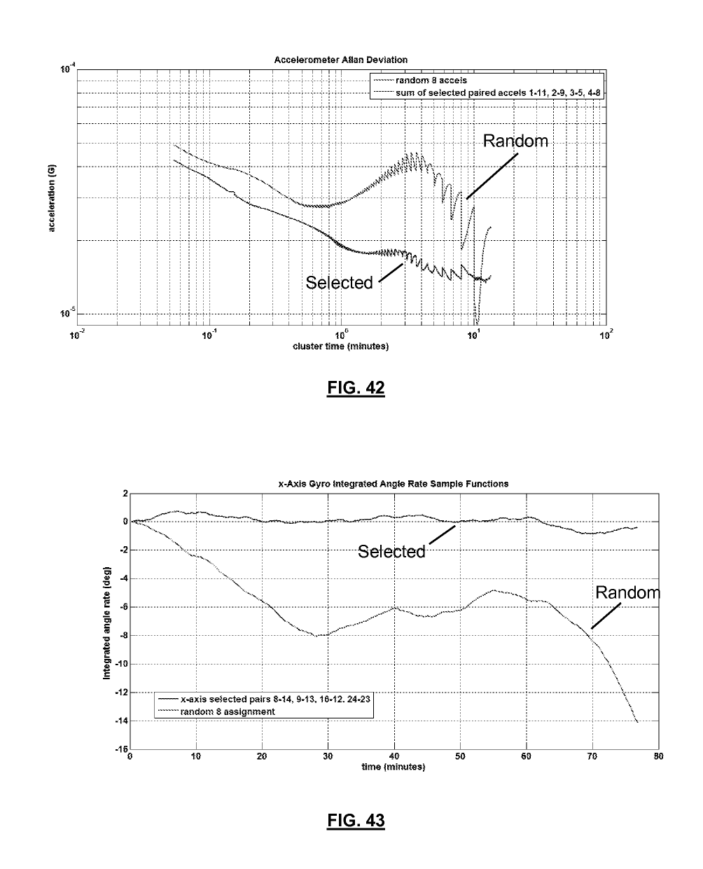

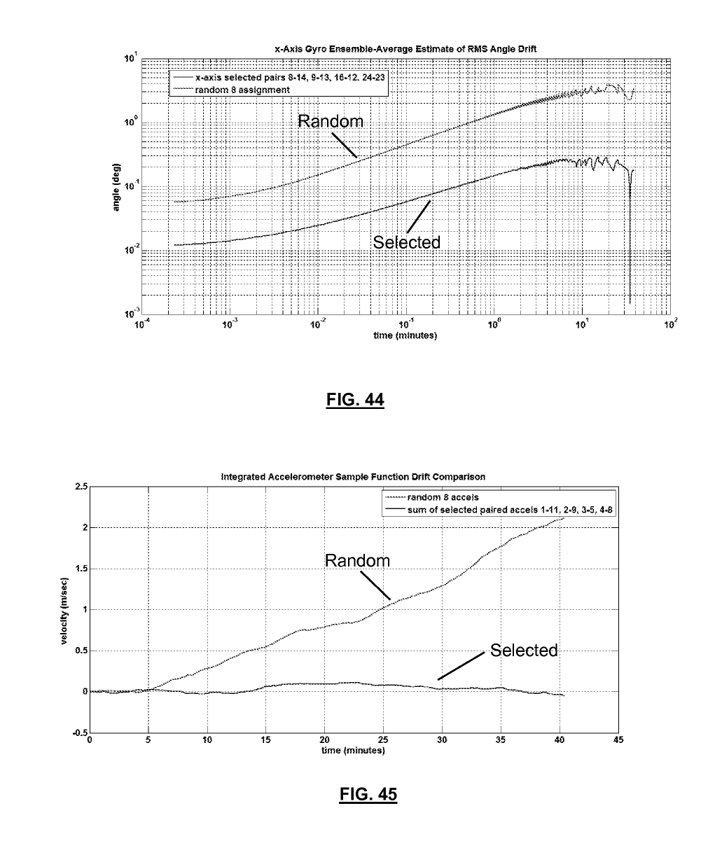

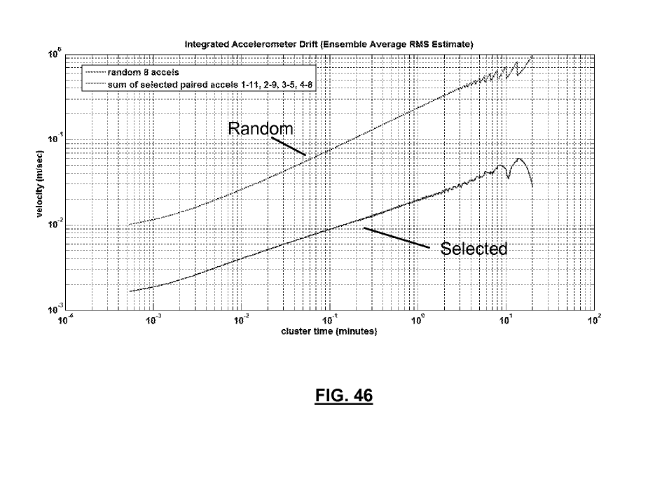

Graphical illustrations showing support for the success of the above described method are illustrated with reference to FIGS. 40-40, wherein FIG. 40 is a graphic illustrating gyro angle versus cluster time of an Allan deviation for gyros with paired low-drift sensors indicating reduced-slope RRW curve; FIG. 41 is a graphic illustrating acceleration versus cluster time of an Allan deviation for accelerometers with paired low-drift sensors indicating reduced-slope RRW curve; FIG. 42 is a graphic illustrating acceleration versus cluster time of an Allan deviation for accelerometers with paired low-drift sensors indicating reduced-slope RRW curve; FIG. 43 is a graphic illustrating integrated angle rate versus time showing reduction of gyro angle drift using direct measurement for sub-optimal pair-combining weights; FIG. 44 is a graphic illustrating angle versus time showing reduction of gyro angle drift using statistical ensemble-average RMS estimate for sub-optimal combining; FIG. 45 is a graphic illustrating velocity versus time showing reduction of accelerometer velocity drift using direct measurement for sub-optimal pair-combining; and FIG. 46 is a graphic illustrating velocity versus cluster time showing reduction of accelerometer velocity drift using statistical ensemble-average RMS estimate for sub-optimal combining.

Further, it will be understood by those of skill in the art that flowcharts and block diagrams herein described may illustrate architecture, functionality, and operation of possible implementations of systems, methods and computer program products according to various embodiments. Therefore, it will be understood that each block in the flowchart or block diagram may represent a module, segment, or portion of code, which comprises one or more executable computer program instructions for implementing the specified logical function or functions. Further, some implementations may include the functions in the blocks occurring out of the order as herein presented. By way of non-limiting example, two blocks shown in succession may be executed substantially concurrently, or the blocks may at times be executed in the reverse order, depending upon the functionality involved. It will also be noted that each block of the block diagrams and flowcharts, and combinations of blocks in the block diagram and flowchart illustrations, may be implemented by special purpose hardware-based systems that perform the specified functions or acts, or combinations of special purpose hardware and computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram. These computer program instructions may also be stored in a computer readable medium that may direct a computer, other programmable data processing apparatus, or other devices to function in a particular manner, such that the instructions stored in the computer readable medium produce an article of manufacture including instructions which implement the function or act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Aspects of various embodiments as herein presented, by way of example, may be embodied as a system, method or computer program product, and accordingly may take the form of a hardware embodiment, a software embodiment (including firmware, resident software, micro-code, and the like) or a combination thereof that may generally be referred to as a circuit, module or system. Furthermore, aspects of various embodiments may take the form of a computer program product embodied in one or more computer readable media having computer readable program code embodied thereon.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction. Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

1. A method for fabricating an inertial measurement unit (IMU) to achieve low-drift measurement accuracy for operation in a GPS-denied environment, the method comprising:
(a) preselecting pairs of gyros for physical assignment within the IMU to achieve low-drift measurement accuracy;
(b) calibrating each gyro within each gyro pair and orthogonalizing the gyro pairs to form a gyro frame;
(c) preselecting individual accelerometers and assigning pairs of accelerometers for the IMU;
(d) calibrating each accelerometer within each accelerometer pair and orthogonalizing the accelerometer pairs to form an accelerometer frame;
(e) aligning the gyro and accelerometer frames with a body frame of the IMU;
(f) applying a gyro weighting function to each gyro and combining the gyros in pairs exhibiting low drift; and
(g) applying an accelerometer weighting function to each accelerometer and combining the accelerometers in pairs exhibiting low drift.

2. The method according to claim 1, wherein the preselecting pairs of gyros comprises:
(a) from a batch of gyros (Bg), pre-selecting a first set (Ng) from the batch for assigning the pre-selected gyros to designated positions on each axis of the IMU;
(b) examining all combinations of the Bg gyros selected in differenced pairs;
(c) comparing a long-duration drift of each differenced pair in angle-rate and in angle-rate integrated to angle using a preselected metric for comparison;
(d) selecting from the Ng gyros a lowest-drift combination of Ng/2 pairs using any individual gyro in the batch gyros only once;
(e) in accordance with positive and negative signs of differenced pairs of gyros in the set of Ng gyros, assigning those gyros to the designated positions on one axis of the IMU;
(f) selecting gyros for assignment to other axes of the IMU; and
(g) repeating the steps a-f by starting with at least one of a new batch of Bg gyros and any remaining gyros from the first set that have been reduced by prior selecting steps.

3. The method according to claim 2, wherein the gyro low-drift combining comprises:
(a) starting with a plurality of the Ng gyros for each axis, assigned to the IMU in Ng/2 pairs preselected for initial low drift; and
(b) creating a summed combination of the Ng/2 gyro pairs on each axis with binary combining weights on successive tiers chosen to minimize the drift in an output of the combined full set of gyro pairs while constrained in such manner that the angular rate being sensed is not distorted.

4. The method according to claim 1, wherein the gyro weighting function combining comprises, given a plurality of the Ng gyros for each axis assigned to the IMU with a summed combination of Ng/2 gyro pairs on each axis, combining weights as for minimizing a quadratic form subject to constraint that the combined weights are positive and sum to unity.

5. The method according to claim 1, wherein the accelerometers are not physically constrained, and wherein the preselecting individual accelerometers and assignment in low-drift pairs comprises pre-selecting a first set of accelerometers (Na) from a batch of accelerometers (Ba) for assigning the pre-selected accelerometers to designated positions on each axis of the IMU, wherein the pre-selecting includes:
(a) examining all combinations of the Na accelerometers selected in differenced pairs;
(b) comparing long-duration drift of each differenced pair using a suitable metric for comparison;
(c) selecting the Na accelerometers having the lowest-drift combination of Na/2 pairs in which any individual accelerometer in the batch of Ba accelerometers is used only once;
(d) in accordance with positive and negative signs of the differenced accelerometer pairs in the set Na, assigning those accelerometers to designated positions on one axis of the IMU; and
(e) selecting another set of accelerometers for assignment to the other axes of the IMU by repeating the steps a-e, starting with a new batch of Ba accelerometers, or the remaining accelerometers from an earlier batch that has been reduced by a prior selection.

6. The method according to claim 1, wherein the accelerometers are tri-axially constrained, and wherein the individual accelerometers preselecting and assignment in pairs comprises preselecting a first set of accelerometers (Na) from a batch of accelerometers (Ba) for assigning to designated positions on one axis of the IMU, wherein the preselecting comprises:
(a) examining all combinations of the Na accelerometers selected in differenced pairs;
(b) comparing long-duration drift of each differenced pair using a suitable metric for comparison;
(c) selecting the Na accelerometers of the lowest-drift combination of Na/2 pairs in which any individual accelerometer in the batch of Ba accelerometers is used only once;
(d) assigning those accelerometers to designated positions on one axis of the IMU in accordance with positive and negative signs of the differenced accelerometers in the set Na; and
(e) for other axes, physically constraining the accelerometers by the tri-axial configuration and the prior assigning on a preferred axis.

7. The method according to claim 1, wherein the accelerometers are not physically constrained, and wherein the accelerometer low-drift pair combining and weight determining is in successive binary tiers and comprises:
(a) preselecting a plurality of Na accelerometers for each axis, assigned to the IMU in Na/2 pairs for initial low drift; and
(b) creating a summed combination of Na/2 gyro pairs on each axis with combining weights chosen in successive binary tiers for minimizing drift in an output of the combined accelerometer pairs while constrained such that the acceleration being sensed is not distorted.

8. The method according to claim 1, wherein the accelerometers are tri-axially constrained physically, and wherein the accelerometer low-drift pair combining and weight determining is successive binary tiers and comprises:
(a) given a plurality of Na triaxial accelerometers for a preferred axis, assigned to IMU, preselecting the accelerometers in Na/2 pairs for initial low drift;
(b) utilizing remaining accelerometers for assigned axes accordingly;
(c) summing a combination of Na/2 accelerometer pairs on a preferred axis with combining weights chosen for minimizing drift in an output of the combined pairs while constrained in such that the acceleration being sensed is not distorted; and
(d) determining a binary combining of weights for accelerometers on remaining axes the assigned sets of pairs of accelerometers on remaining axes using a consistent constrained minimization algorithm.

9. The method according to claim 1, wherein the accelerometers are at least one of not physically constrained and tri-axially constrained, and wherein the accelerometer low-drift combining employs constrained optimization comprising:
(a) providing a plurality of the Na accelerometers for each axis, assigned to the IMU with a summed combination of Na/2 accelerometer pairs on each axis;
(b) determining optimal weights for combining the Na/2 accelerometer pairs on each axis;
(c) determining minimize drift in the output of the combined accelerometer pairs while constrained in such manner that the acceleration being sensed is not distorted; and
(c) determining an optimal combined weights based on constrained optimization using a mathematical algorithms.
